(19) United States
(12) Patent Application Publication
(10) Pub. No.: US 2026/0312877 A1
(43) Pub. Date: Oct. 8, 2026

(54) PREDICTION APPARATUS, COMMUNICATION CONTROL APPARATUS AND PREDICTION METHOD

(71) Applicant: NTT, Inc., Tokyo (JP)

(72) Inventors: Yuka OKAMOTO, Musashino-shi (JP); Hirotaka UJIKAWA, Musashino-shi (JP); Yoshihito SAKAI, Musashino-shi (JP); Tatsuya SHIMADA, Musashino-shi (JP)

(73) Assignee: NTT, Inc., Tokyo (JP)

(21) Appl. No.: 19/483,637

(22) PCT Filed: May 17, 2023
(86) PCT No.: PCT/JP2023/018384

§ 371 Date: Nov. 12, 2025

(51) Int. Cl. H04L 41/147

(52) U.S. Cl. CPC H04L 41/147

(57) ABSTRACT

A prediction apparatus includes a flow classification unit configured to classify communication traffic input during a predetermined period into a plurality of flows on a basis of a characteristic of the communication traffic, a parallel-processable number calculation unit configured to calculate a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition, a traffic prediction unit configured to perform the prediction processing for a number of the flows within the parallel-processable number in a case where the number of flows classified by the flow classification unit is larger than the parallel-processable number, and a total traffic calculation unit configured to calculate a total of the traffic amounts in the second period on a basis of a result of the prediction processing by the traffic prediction unit.

### TECHNICAL FIELD

The present invention relates to a prediction apparatus, a communication control apparatus and a prediction method.

### BACKGROUND ART

In a case where communication is simultaneously performed by a plurality of communication apparatuses, such as a case where a plurality of upper apparatuses and a plurality of lower apparatuses communicate with each other, congestion may occur and a communication delay may occur. The congestion may be resolved by switching a communication path (hereinafter referred to as “path switching”) by a switching apparatus installed in the communication path and changing a connection relationship between the upper apparatus and the lower apparatus. If communication traffic (hereinafter simply referred to as “traffic”) concentrated on a specific communication apparatus (for example, an upper apparatus) can be distributed to a plurality of communication apparatuses by the path switching, the congestion can be eliminated, and the communication delay can be reduced.

Conventionally, in a communication system including a switching apparatus capable of changing a connection relationship between an upper apparatus and a lower apparatus, there is a technology of collecting information (hereinafter simply referred to as “traffic amount”) indicating an amount of traffic measured by the upper apparatus or the lower apparatus, determining the presence or absence of occurrence of congestion at an offload destination on the basis of the collected traffic amount, and performing path switching.

### CITATION LIST

### Patent Literature

Patent Literature 1: JP 2014-060610 A
Patent Literature 2: JP 10-285276 A

### Non Patent Literature

Non Patent Literature 1: Y. Okamoto, et al., “Short-term traffic prediction based on mobile control information for proactive optical switching to lower congestion delay,” International Conference on Emerging Technologies for Communications (ICETC), 2022

### SUMMARY OF INVENTION

### Technical Problem

A conventional communication system calculates a congestion value indicating a degree of congestion on the basis of a traffic amount of each communication path, and performs path switching in a case where the congestion value of any communication path exceeds a threshold. However, in general, it takes a certain time to perform the path switching. Therefore, in the conventional communication system, the congestion is kept generated from the occurrence of the congestion to completion of the path switching. Therefore, the time required for the path switching is also one of factors of the communication delay. For example, in the techniques described in Patent Literatures 1 and 2, since it takes time from collection of an actual traffic amount to execution of path switching, it is difficult to determine the presence or absence of occurrence of congestion in real time (for example, in several milliseconds) and execute the path switching within a predetermined period (for example, within several tens of milliseconds).

In contrast, a method of avoiding occurrence of congestion by predicting a future traffic amount and performing path switching in advance on the basis of a prediction value instead of performing the path switching on the basis of an actual measurement value of the traffic amount is conceivable. However, in an actual communication environment in which a plurality of traffic flows (hereinafter simply referred to as “flows”) is mixed as in recent communication performed with various types of quality of service (QoS) among a large number of communication apparatuses, there is a problem that prediction accuracy is lowered if future traffic amounts of all the flows are collectively predicted.

Meanwhile, in a case where the future traffic amount is predicted for each flow, there is a problem that a calculation load related to the prediction increases in proportion to the number of flows, the calculation time required for the prediction becomes long, and the path switching cannot be completed before the congestion actually occurs. As described above, the conventional techniques have a problem that even if execution determination of the path switching is performed on the basis of the prediction value of the traffic amount, the occurrence of congestion cannot be prevented and the communication delay may occur.

In view of the above circumstances, an object of the present invention is to provide a prediction apparatus, a communication control apparatus and a prediction method capable of reducing a communication delay while satisfying communication quality even in a case where a plurality of flows is mixed.

### Solution to Problem

One aspect of the present invention is a prediction apparatus including: a flow classification unit configured to classify communication traffic input during a predetermined period into a plurality of flows on a basis of a characteristic of the communication traffic; a parallel-processable number calculation unit configured to calculate a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition; a traffic prediction unit configured to perform the prediction processing for a number of the flows within the parallel-processable number in a case where the number of flows classified by the flow classification unit is larger than the parallel-processable number; and a total traffic calculation unit configured to calculate a total of the traffic amounts in the second period on a basis of a result of the prediction processing by the traffic prediction unit.

One aspect of the present invention is a communication control apparatus including: a flow classification unit configured to classify communication traffic input during a predetermined period into a plurality of flows on a basis of a characteristic of the communication traffic; a parallel-processable number calculation unit configured to calculate a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition; a traffic prediction unit configured to perform the prediction processing for a number of the flows within the parallel-processable number in a case where the number of flows classified by the flow classification unit is larger than the parallel-processable number; a total traffic calculation unit configured to calculate a total of the traffic amounts in the second period on the basis of a result of the prediction processing by the traffic prediction unit; a switching determination unit configured to predict presence or absence of occurrence of congestion in the second period on a basis of a total value of the traffic amounts, and determine necessity of switching of a communication path on a basis of a prediction result; and a switching instruction unit configured to issue a switching instruction to a switching apparatus that executes the switching of a communication path in a case where the switching determination unit determines that the switching of a communication path is necessary.

Further, one aspect of the present invention is a prediction method executed by a computer, the prediction method including: a flow classification step of classifying communication traffic input during a predetermined period into a plurality of flows on a basis of a characteristic of the communication traffic; a parallel-processable number calculation step of calculating a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition; a traffic prediction step of performing the prediction processing for a number of the flows within the parallel-processable number in a case where the number of flows classified by the flow classification step is larger than the parallel-processable number; and a total traffic calculation step of calculating a total of the traffic amounts in the second period on the basis of a result of the prediction processing by the traffic prediction step.

### Advantageous Effects of Invention

According to the present invention, it is possible to suppress occurrence of congestion and reduce a communication delay while satisfying communication quality even in a case where a plurality of flows is mixed.

### BRIEF DESCRIPTION OF DRAWINGS

FIG. 1 is a diagram illustrating a configuration of a communication system 1 that is an example of a conventional communication system.

FIG. 2 is a diagram illustrating a configuration of a mobile communication system 10 that is an example of a conventional communication system.

FIG. 3 is a block diagram illustrating a configuration of a switching instruction apparatus 17 of the mobile communication system 10 that is an example of a conventional communication system.

FIG. 4 is a diagram illustrating a flow of processing in the switching instruction apparatus 17 of the mobile communication system 10 that is an example of a conventional communication system.

FIG. 5 is a flowchart illustrating distributed station traffic amount prediction processing in the prediction unit 171.

FIG. 6 is a flowchart illustrating traffic amount prediction model creation processing of the prediction unit 171.

FIG. 7 is a flowchart illustrating future traffic amount prediction processing of the prediction unit 171.

FIG. 8 is a flowchart illustrating upper link traffic amount prediction processing in the prediction unit 171.

FIG. 9 is a flowchart illustrating switching threshold calculation processing in a switching threshold determination unit 172.

FIG. 10 is a table illustrating an example of a lookup table. The lookup table is data in which prediction accuracy is associated with calculation formulas of an error rate and a switching threshold.

FIG. 11 is a flowchart illustrating switching determination processing in a switching determination unit 175.

FIG. 12 is a flowchart illustrating the switching determination processing in the switching determination unit 175.

FIG. 13 is a block diagram illustrating a functional configuration of a prediction unit 171a of the communication system in a first embodiment of the present invention.

FIG. 14 is a schematic diagram for describing definition of a flow as a precondition in the first embodiment of the present invention.

FIG. 15 is a table illustrating an example of a configuration of a flow information table in the first embodiment of the present invention.

FIG. 16 is a block diagram illustrating a functional configuration of a grouping prediction unit 730 of the communication system in the first embodiment of the present invention.

FIG. 17 is a block diagram illustrating a functional configuration of a prediction unit 171b of the communication system in a second embodiment of the present invention.

FIG. 18 is a diagram for describing a functional configuration of a parallel-processable number calculation unit 731b of the communication system in the second embodiment of the present invention.

FIG. 19 is a block diagram illustrating a functional configuration of a prediction unit 171c of the communication system in a third embodiment of the present invention.

FIG. 20 is a block diagram illustrating a functional configuration of a grouping prediction unit 730c of the communication system in the third embodiment of the present invention.

FIG. 21 is a flowchart illustrating an operation of the grouping prediction unit 730c of the communication system in the third embodiment of the present invention.

FIG. 22 is a block diagram illustrating a functional configuration of a prediction unit 171d of the communication system in a fourth embodiment of the present invention.

FIG. 23 is a block diagram illustrating a functional configuration of a grouping prediction unit 730d of the communication system in the fourth embodiment of the present invention.

FIG. 24 is a flowchart illustrating an operation of the grouping prediction unit 730d of the communication system in the fourth embodiment of the present invention.

FIG. 25 is a flowchart illustrating an operation of the grouping prediction unit 730d of the communication system in the fourth embodiment of the present invention.

FIG. 26 is a block diagram illustrating a functional configuration of a prediction unit 171e of the communication system in a fifth embodiment of the present invention.

FIG. 27 is a block diagram illustrating a functional configuration of a grouping prediction unit 730e of the communication system in the fifth embodiment of the present invention.

FIG. 28 is a flowchart illustrating an operation of the grouping prediction unit 730e of the communication system in the fifth embodiment of the present invention.

FIG. 29 is a block diagram illustrating a functional configuration of a prediction unit 171f of the communication system in a sixth embodiment of the present invention.

FIG. 30 is a block diagram illustrating a functional configuration of a grouping prediction unit 730f of the communication system in the sixth embodiment of the present invention.

FIG. 31 is a block diagram illustrating a functional configuration of a prediction unit 171g of the communication system in a seventh embodiment of the present invention.

FIG. 32 is a block diagram illustrating functional configurations of a switching threshold determination unit 172g and a switching determination unit 175g of the switching instruction apparatus 17g in the seventh embodiment of the present invention.

FIG. 33 is a flowchart illustrating an operation of a switching flow calculation unit 177 of the switching determination unit 175g in the seventh embodiment of the present invention.

FIG. 34 is a diagram illustrating a basic processing flow by a switching instruction apparatus in each embodiment of the present invention.

FIG. 35 is a diagram for describing execution timing of grouping processing by a flow classification unit by parallel number in each embodiment of the present invention.

FIG. 36 is a diagram for describing the execution timing of the grouping processing by the flow classification unit by parallel number in each embodiment of the present invention.

### DESCRIPTION OF EMBODIMENTS

Hereinafter, a prediction apparatus, a communication control apparatus and a prediction method according to embodiments of the present invention will be described in detail with reference to the drawings. Note that, in the embodiments, components having the same function are denoted by the same reference numerals, and repeated description of the function may be omitted.

Hereinafter, to make description of configurations of communication systems in the embodiments of the present invention easier to understand, an example of a configuration of a conventional communication system as a comparison target will be described first.

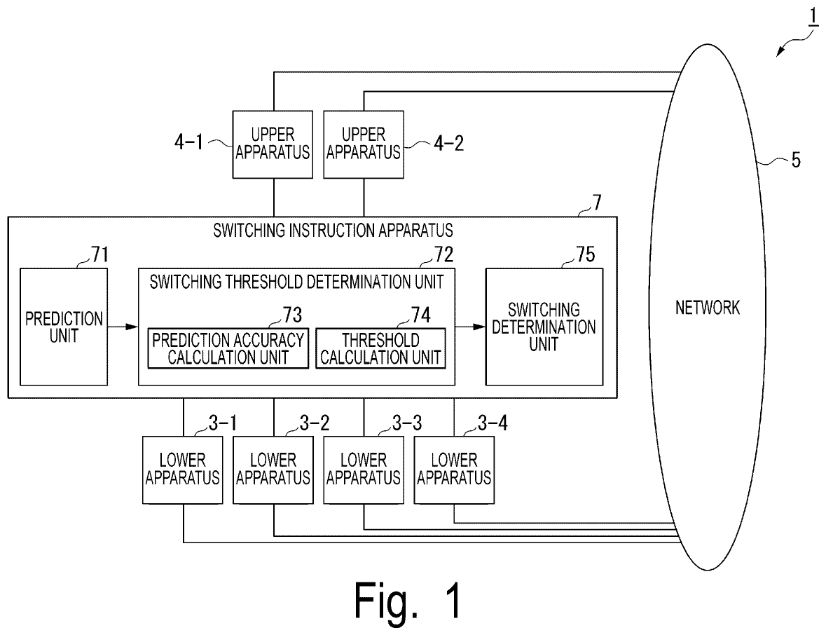

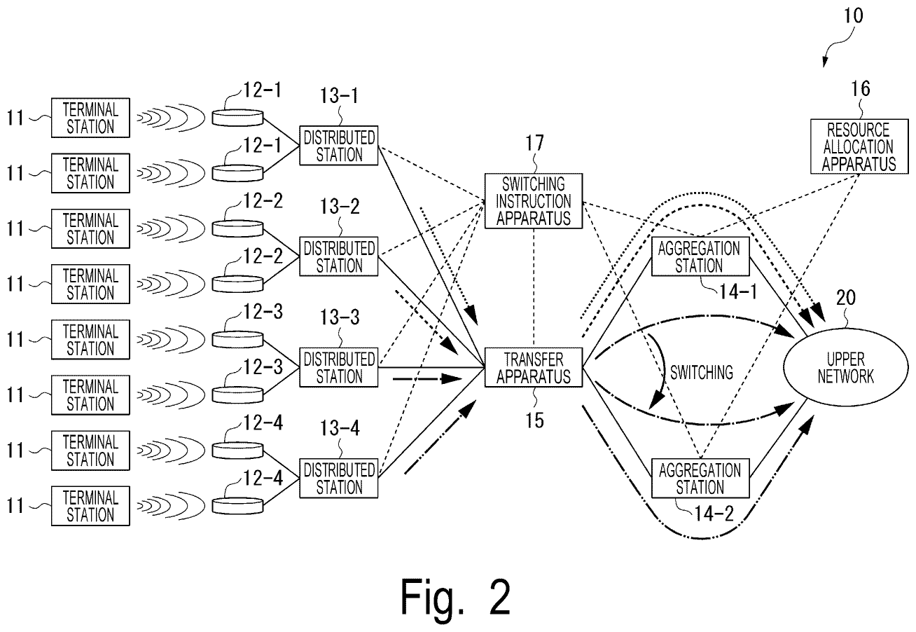

FIG. 1 is a diagram illustrating a configuration of a communication system 1 that is an example of a conventional communication system. The communication system 1 includes a plurality of lower apparatuses 3, a plurality of upper apparatuses 4, and a switching instruction apparatus 7. The lower apparatuses 3 and the upper apparatuses 4 are connected via a network 5. The network 5 includes one or more transfer apparatuses (that are not illustrated and correspond to a transfer apparatus 15 illustrated in FIG. 2 to be described below). The transfer apparatus also functions as a switching apparatus capable of changing a connection relationship between the lower apparatus 3 and the upper apparatus 4.

In FIG. 1, the four lower apparatuses 3 are referred to as lower apparatuses 3-1 to 3-4, and the two upper apparatuses 4 are referred to as upper apparatuses 4-1 and 4-2. A direction from the lower apparatus 3 to the upper apparatus 4 is described as “uplink”, and a direction from the upper apparatus 4 to the lower apparatus 3 is described as “downlink”.

The lower apparatus 3 transmits an uplink signal to the upper apparatus 4 at a connection destination. The network 5 transfers the uplink signal to the upper apparatus 4 according to a communication path between the lower apparatus 3 and the upper apparatus 4. Further, the upper apparatus 4 transmits a downlink signal to the lower apparatus 3 at the connection destination. The network 5 transfers the downlink signal to the lower apparatus 3 according to the communication path between the lower apparatus 3 and the upper apparatus 4. The switching instruction apparatus 7 instructs each apparatus such as the transfer apparatus to switch the communication path.

The switching instruction apparatus 7 predicts traffic amounts of some or all of communication links (hereinafter simply referred to as “links” or “flows”) in the communication path between the lower apparatus 3 and the upper apparatus 4 in advance, using information of traffic amounts, traffic allocation amounts, and the like (hereinafter collectively referred to as “traffic amounts”) acquired from the lower apparatus 3 and the upper apparatus 4. The switching instruction apparatus 7 determines a switching threshold for each link on the basis of prediction accuracy of the traffic amount and transmission capability of the link.

For example, a link rate can be used as the transmission capability of the link. The link rate is a maximum communication speed of the link. The switching threshold is a threshold used to determine whether occurrence of congestion that requires switching of the communication path (path switching) is predicted. For example, even at the same link rate, the switching instruction apparatus 7 determines the switching threshold to be lower as the prediction accuracy is lower.

The switching instruction apparatus 7 determines, for each link, whether congestion occurs using information of the predicted traffic amount and the switching threshold. In a case of predicting the occurrence of congestion in any link, the switching instruction apparatus 7 determines to perform the path switching for load distribution. The switching instruction apparatus 7 gives an instruction for switching of the communication path so that at least some of the traffic transmitted by the link predicted to have congestion is transmitted by a link predicted not to have congestion. As a result, it is possible to perform optimum switching of the communication path according to the prediction accuracy. In addition, a congestion delay of the link is reduced, and high utilization efficiency of a band is realized.

As illustrated in FIG. 1, the switching instruction apparatus 7 includes a prediction unit 71, a switching threshold determination unit 72, and a switching determination unit 75. The prediction unit 71 acquires prediction information used to predict the traffic amount of each link from each apparatus. The prediction information is, for example, information of the traffic amount observed by the apparatus, the traffic allocation amount to the apparatus, the number of connected terminals of the apparatus, communication quality, and the like. The prediction unit 71 predicts a future traffic amount for each link (hereinafter referred to as “future traffic amount”), using the prediction information. Note that any existing technique is used to predict the future traffic amount.

The switching threshold determination unit 72 includes a prediction accuracy calculation unit 73 and a threshold calculation unit 74. The prediction accuracy calculation unit 73 obtains the prediction accuracy for each link using a prediction result of the future traffic amount in the past and the actual traffic amount. The threshold calculation unit 74 determines the switching threshold for each link so that the lower the prediction accuracy, the lower the ratio to the transmission capability of the link (for example, the link rate).

The switching determination unit 75 determines in advance the presence or absence of occurrence of congestion for each link using a value of the predicted future traffic amount and the switching threshold. In a case where the occurrence of congestion is predicted, the switching determination unit 75 determines to perform the path switching for load distribution. For example, the switching determination unit 75 determines to execute the path switching from a link in which occurrence of congestion is predicted to a link with a low link use rate. The switching determination unit 75 instructs each apparatus to perform processing for the path switching.

Hereinafter, an example in which the communication system 1 is applied to a mobile communication system will be described.

FIG. 2 is a diagram illustrating a configuration of a mobile communication system 10 that is an example of a conventional communication system. The mobile communication system 10 is an example of the communication system 1. The mobile communication system 10 is, for example, a fifth generation mobile communication system (5G). The mobile communication system 10 includes a plurality of terminal stations 11, a plurality of antenna stations 12, a plurality of distributed stations 13, a plurality of aggregation stations 14, a transfer apparatus 15, a switching instruction apparatus 17, and a resource allocation apparatus 16.

The terminal station 11, the antenna station 12, the distributed station 13, and the aggregation station 14 are user equipment (UE), a radio unit (RU), a distributed unit (DU), and a central unit (CU) of the fifth generation mobile communication system, respectively. The distributed station 13 is an example of the lower apparatus 3, and the aggregation station 14 is an example of the upper apparatus 4. The transfer apparatus 15 is an example of a transfer apparatus constituting the network 5.

The transfer apparatus 15 also functions as a switching apparatus capable of changing a connection relationship between the distributed station 13 and the aggregation station 14. Note that the transfer function and the switching function of the transfer apparatus 15 may be configured as separate apparatuses. Note that the apparatuses such as the switching instruction apparatus 17, the transfer apparatus 15, and the resource allocation apparatus 16 may be configured as an integrated apparatus.

The mobile communication system 10 is connected to an upper network 20. Here, M (M is an integer of 1 or more) distributed stations 13 are referred to as distributed stations 13-1 to 13-M, respectively. Furthermore, Km (Km is an integer of 1 or more) antenna stations 12 subordinate to the distributed station 13-m (m is an integer of 1 or more and M or less) are referred to as antenna stations 12-m. Further, N (N is an integer of 2 or more) aggregation stations 14 are referred to as aggregation stations 14-1 to 14-N, respectively. Therefore, the mobile communication system 10 illustrated in FIG. 2 is an example of a mobile communication system with M=4, K1=2, K2=2, K3=2, K4=2, and N=2.

The terminal station 11 transmits and receives radio signals to and from the antenna station 12 using a radio resource allocated from the distributed station 13. The allocated radio resource includes information indicating start timing and end timing of a time section in which each of transmission and reception of radio signals is permitted. The start timing and the end timing are represented by slots, for example. A slot is a scheduling unit of data transmission and reception in a radio frame. The allocated radio resource may further include information indicating a coding rate and a modulation scheme.

The antenna station 12 receives uplink data from the terminal station 11 by a radio signal. The antenna station 12-m sets the received uplink data as an uplink signal and transmits the uplink signal to the distributed station 13-m by a wired interface. Further, the antenna station 12-m receives a downlink signal from the distributed station 13-m via the wired interface. The antenna station 12 transmits downlink data addressed to the terminal station 11 set as the received downlink signal to the terminal station 11 by a radio signal.

The distributed station 13-m receives the uplink signal from each of the Km antenna stations 12-m. The uplink signal received by the distributed station 13-m includes the uplink data received by the antenna station 12-m from the subordinate terminal station 11. The distributed station 13 generates an uplink signal obtained by aggregating the uplink data, and transmits the generated uplink signal to the aggregation station 14 as the connection destination of the own unit. Further, the distributed station 13 receives the downlink signal in which the downlink data addressed to the subordinate terminal station 11 is set from the aggregation station 14 as the connection destination of the own station. The distributed station 13-m converts the received downlink signal into a downlink signal corresponding to the radio signal to be transmitted from each antenna station 12-m. The distributed station 13-m transmits the converted downlink signal to the antenna station 12-m corresponding to the downlink signal.

The aggregation station 14 aggregates the uplink signals received from the subordinate distributed stations 13 and transfers the uplink signals to the upper network 20. In addition, the aggregation station 14 receives the downlink signal in which the downlink data addressed to the terminal station 11 is set from the upper network 20, and transfers the received downlink signal to the distributed station 13 connected to the addressed terminal station 11.

The transfer apparatus 15 (switching apparatus) is connected to the distributed station 13, the aggregation station 14, and the switching instruction apparatus 17. The transfer apparatus 15 transfers a signal according to the communication path between the distributed station 13 and the aggregation station 14. That is, the transfer apparatus 15 transfers the uplink signal received from the distributed station 13 to the addressed aggregation station 14 according to the communication path. In addition, the transfer apparatus 15 transfers the downlink signal received from the aggregation station 14 to the addressed distributed station 13 according to the communication path. The transfer according to the communication path is instructed from the switching instruction apparatus 17. The resource allocation apparatus 16 manages resources of the aggregation station 14.

The switching instruction apparatus 17 is connected to the distributed station 13, the aggregation station 14, and the transfer apparatus 15. Further, the switching instruction apparatus 17 may be connected to the resource allocation apparatus 16. The switching instruction apparatus 17 instructs the transfer apparatus 15 (switching apparatus) to switch the communication path between the distributed station 13 and the aggregation station 14. In the mobile communication system 10, the communication path between the distributed station 13 and the aggregation station 14 is determined according to the connection relationship between the distributed station 13 and the aggregation station 14. Therefore, the mobile communication system 10 performs the path switching between the distributed station 13 and the aggregation station 14 by controlling the transfer apparatus 15 (switching apparatus) so as to change the aggregation station 14 as the connection destination of the distributed station 13.

In addition, here, the switching instruction apparatus 17 of the mobile communication system 10 is assumed to determine the presence or absence of occurrence of congestion on the basis of uplink traffic. Therefore, the traffic referred to herein means uplink signal traffic unless otherwise specified.

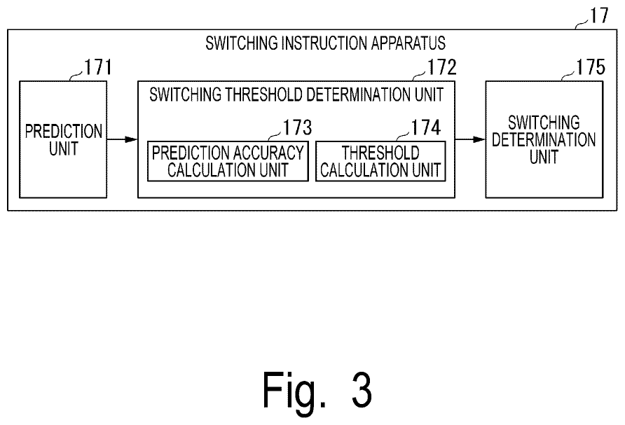

FIG. 3 is a block diagram illustrating a configuration of the switching instruction apparatus 17 of the mobile communication system 10 that is an example of a conventional communication system. The switching instruction apparatus 17 includes a prediction unit 171, a switching threshold determination unit 172, and a switching determination unit 175.

The prediction unit 171 receives the radio information as the prediction information from the distributed station 13. The radio information indicates the radio resource allocated to the subordinate terminal station 11 of the distributed station 13. The radio information is, for example, downlink control information (DCI). The prediction unit 171 calculates the future traffic amount of each distributed station 13 using the radio information from the distributed station 13.

Further, the prediction unit 171 calculates a future traffic amount of each upper link on the basis of the connection relationship between the distributed station 13 and the aggregation station 14 and the future traffic amount of each distributed station 13. The upper link is a link between the aggregation station 14 and the transfer apparatus 15. An uplink traffic amount of the upper link between the aggregation station 14-n (n is an integer of 1 or more and N or less) and the transfer apparatus 15 corresponds to a sum of the traffic amounts of the uplink signals received by the aggregation station 14-n from the respective subordinate distributed stations 13. The prediction unit 171 outputs the future traffic amount of the upper link to the switching threshold determination unit 172 and the switching determination unit 175.

The switching threshold determination unit 172 includes a prediction accuracy calculation unit 173 and a threshold calculation unit 174. The prediction accuracy calculation unit 173 receives information indicating the actual traffic amount from the distributed station 13. The prediction accuracy calculation unit 173 calculates the actual traffic amount actually flowing to each upper link on the basis of the actual traffic amount from the distributed station 13 and the connection relationship between the distributed station 13 and the aggregation station 14. The prediction accuracy calculation unit 173 calculates the prediction accuracy for each upper link on the basis of the future traffic amount predicted in the past by the prediction unit 171 and the actual traffic amount. The threshold calculation unit 174 calculates the switching threshold for each upper link on the basis of the link rate and the prediction accuracy. The threshold calculation unit 174 outputs the switching threshold of each upper link to the switching determination unit 175.

The switching determination unit 175 obtains a predicted link use rate for each upper link using the value of the future traffic amount received from the prediction unit 171 and the switching threshold received from the threshold calculation unit 174. In a case where there is an upper link determined to have congestion due to a high predicted link use rate, the switching determination unit 175 determines to perform the path switching by changing the aggregation station 14 as the connection destination of the distributed station 13. In a case of determining to perform the path switching, the switching determination unit 175 instructs each apparatus (the distributed station 13, the aggregation station 14, and the transfer apparatus 15) to perform the path switching.

Specifically, the switching determination unit 175 instructs the aggregation station 14 as the connection destination before the path switching (hereinafter referred to as a “switching source”) to release the connection with the distributed station 13, and instructs the aggregation station 14 as the connection destination after the path switching (hereinafter, “switching destination”) to be connect with the distributed station 13. Further, the switching instruction apparatus 17 instructs the transfer apparatus 15 (switching apparatus) to perform the path switching so that signal transfer is performed through the communication path after the path switching.

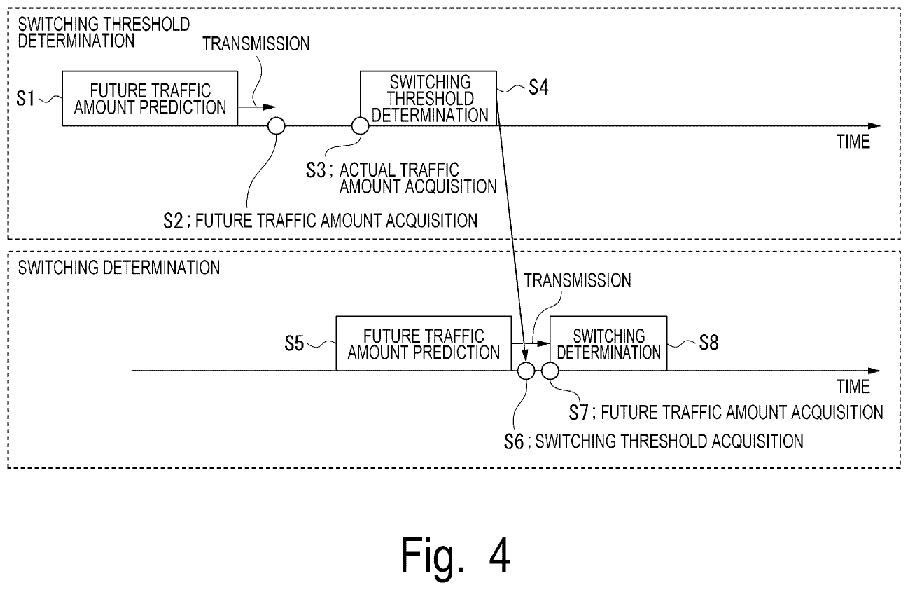

FIG. 4 is a diagram illustrating a flow of processing in the switching instruction apparatus 17 of the mobile communication system 10 that is an example of a conventional communication system. For example, the prediction unit 171 predicts the future traffic amount of the upper link in a period D(a) (step S1). The prediction accuracy calculation unit 173 acquires information indicating the future traffic amount predicted in step S1 from the prediction unit 171 and stores the information until acquiring the information indicating the actual traffic amount in the period D(a) (step S2).

The prediction accuracy calculation unit 173 receives the information indicating the actual traffic amount in the period D(a) of the upper link (step S3). The prediction accuracy calculation unit 173 calculates the prediction accuracy on the basis of the stored future traffic amount in the period D(a) and the received actual traffic amount in the period D(a). The threshold calculation unit 174 determines the switching threshold on the basis of the link rate and the prediction accuracy of the upper link (step S4). The threshold calculation unit 174 outputs the determined switching threshold to the switching determination unit 175.

Meanwhile, the prediction unit 171 calculates the future traffic amount of the upper link in a period D(b) that is a period after the period D(a) (step S5). The switching determination unit 175 acquires the switching threshold output in step S4 from the threshold calculation unit 174 (step S6). Further, the switching determination unit 175 acquires information indicating the future traffic amount in the period D(b) calculated in step S5 from the prediction unit 171 (step S7). The switching determination unit 175 determines necessity of the path switching on the basis of the switching threshold and a value of the future traffic amount in the period D(b) (step S8).

As described above, the future traffic amount acquired by the switching threshold determination unit 172 is a traffic amount at time earlier than the future traffic amount acquired by the switching determination unit 175.

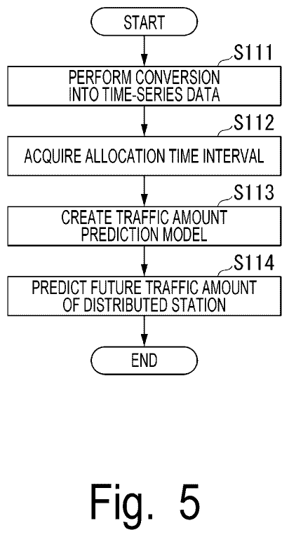

Next, detailed processing of the switching instruction apparatus 17 will be described. First, processing of predicting the future traffic amount of each upper link in the prediction unit 171 will be described. The prediction unit 171 performs the processing of steps S1 and S5 of FIG. 4 by processing of FIGS. 5 to 8 below.

FIG. 5 is a flowchart illustrating distributed station traffic amount prediction processing in the prediction unit 171. At time t(i−1), the distributed station 13 notifies the terminal station 11 of DCI(i) of a next transmission period, and further notifies the switching instruction apparatus 17 of DCI information in which the DCI(i) is set (i is an integer). DCI(i) is DCI indicating the radio resource allocated to the terminal station 11 in slot SL(i) from time t(i) to time t(i+1), and the coding rate and the modulation scheme used by terminal station 11. Specifically, the DCI includes scheduling information necessary for the terminal station 11 to transmit the uplink data, a modulation and coding scheme (MCS), and the like. The scheduling information is represented by a resource block. The resource block is represented by a channel, and transmission start timing and transmission end timing using the channel. The MCS represents data modulation and a channel coding rate. A transport block size (TBS) is determined on the basis of the size of the resource block and the MCS. The traffic amount can be predicted with the TBS.

The switching instruction apparatus 17 receives DCI information in which the DCI(i) is set from each distributed station 13 at time t(i−1). The prediction unit 171 calculates a predicted traffic amount DU(i) of the distributed station 13 in the period D(i) corresponding to the slot SL(i) on the basis of the information included in the DCI(i) (step S111). Further, the prediction unit 171 calculates an allocation time interval T(i) from a difference between time t(i) and time t(i+1) (step S112). The allocation time interval T(i) corresponds to a time length of the slot SL(i), that is, a time length of the period D(i) from time t(i) to time t(i+1). The prediction unit 171 may receive the allocation time interval T(i) from the distributed station 13. The prediction unit 171 stores the predicted traffic amount DU(i) of each distributed station 13, the allocation time interval T(i), and the period D(i) in association with one another.

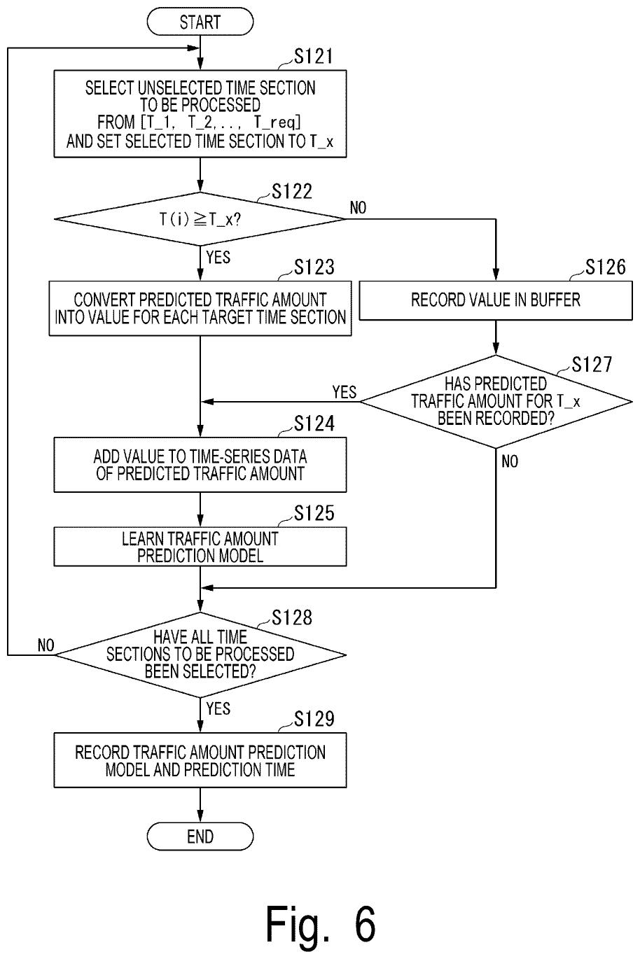

The prediction unit 171 creates a traffic amount prediction model (step S113). The traffic amount prediction model is a model that uses the traffic amounts of time-series q (for example, q=100) slots as input data and predicts the traffic amount of a slot next to the input data. Details of the creation of the traffic amount prediction model will be described below with reference to FIG. 6.

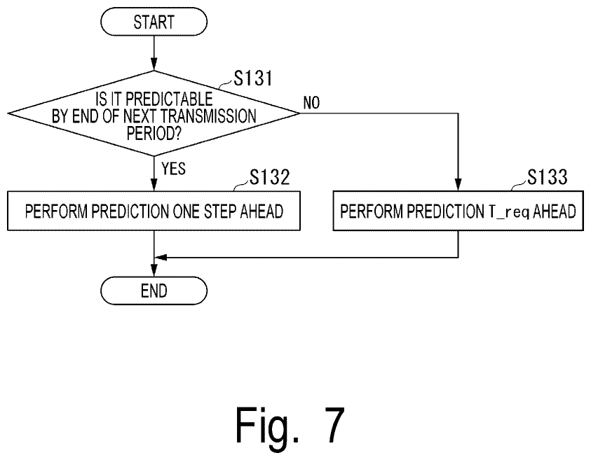

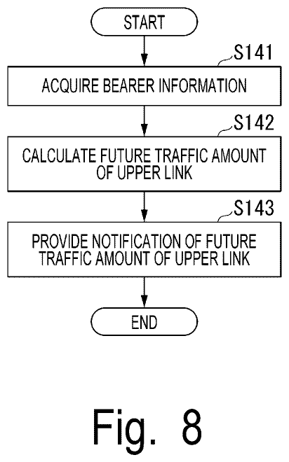

The prediction unit 171 predicts the future traffic amount DU(i+1) of each distributed station 13 in the period D(i+1) from time t(i+1) to time t(i+2) using the traffic amount prediction model created in step S113 (step S114). Details of the prediction processing will be described below with reference to FIG. 7. After the processing of step S114, the prediction unit 171 performs processing of FIG. 8 to be described below and calculates the traffic amount for each upper link.

FIG. 6 is a flowchart illustrating traffic amount prediction model creation processing of the prediction unit 171. FIG. 6 illustrates detailed processing in step S113 of FIG. 5.

The prediction unit 171 stores K time sections T_1, T_2, . . . , T_k−1, and T_req to be processed in advance. The time sections T_1 to T_k−1 are the time lengths of the slots that can be used when the resource blocks are allocated to the terminal station 11. For example, T_1 to T_k−1 are 125 us, 250 us, 500 us, and 1 ms. The allocation time interval T(i) has the same value as any one of the time sections T_1 to T_k−1. The time section T_req is a value required by an application or the like. The time section T_req is a value larger than T_1 to T_k−1. The prediction unit 171 selects one of the unselected time sections T_1 to T_req and sets the selected time section to T_x (step S121).

The prediction unit 171 determines whether or not the allocation time interval T(i) is equal to or greater than to the time section T_x (step S122). In a case of determining that the allocation time interval T(i) is equal to or greater than the time section T_x (step S122: YES), the prediction unit 171 converts the predicted traffic amount DU(i) of the distributed station 13 into the predicted traffic amount for each time section T_x (step S123). That is, the prediction unit 171 calculates that the predicted traffic amount DU_T_x of the predicted traffic amount DU(i)×(the time section T_x/the allocation time interval T(i)) is generated for each time section T_x between time t(i) and time t(i+1). For example, it is assumed that the allocation time interval T(i) is 250 us and the time section T_x is 125 us. The prediction unit 171 predicts that the traffic amount DU_125 us=DU(i)/2 is to be generated between time t(i) and time t(i)+125 us and between time t(i)+125 us and time t(i+1).

The prediction unit 171 additionally stores the predicted traffic amount calculated in step S123 to the time-series predicted traffic amounts calculated in the past for the time section T_x for each distributed station 13 (step S124). The prediction unit 171 learns the traffic amount prediction model of the time section T_x using the stored time-series predicted traffic amounts of the distributed station 13 in the time section T_x (step S125).

For example, the time-series predicted traffic amounts of the distributed station 13 in the time section T_x are DU_T_x(P), DU_T_x(P−1), DU_T_x(P−2), . . . , DU_T_x(1) in reverse chronological order (P is an integer of 2 or more). The prediction unit 171 generates, for each distributed station 13, learning data having DU_T_x(p) as correct output data and DU_T_x(p−1) to DU_T_x(p−q) as input data while sequentially subtracting the value of p from P by 1 (q is an integer of 1 or more, for example, q=100). The prediction unit 171 learns the traffic amount prediction model representing a correspondence between the input data and output data using the generated learning data.

On the other hand, in step S122, in a case of determining that the allocation time interval T(i) is smaller than the time section T_x (step S122: NO), the prediction unit 171 performs the processing of step S126. The prediction unit 171 records the predicted traffic amount DU(i) of the distributed station 13-m in a buffer corresponding to the distributed station 13-m and the time section T_x in the prediction unit 171 (step S126). The prediction unit 171 determines whether or not the predicted traffic amount for the time section T_x has been recorded in the buffer corresponding to each distributed station 13 and the time section T_x (step S127). For example, it is assumed that the allocation time interval T(i) is 250 us and the time section T_x is 500 us. The prediction unit 171 determines whether the predicted traffic amount corresponding to T_x/T(i)=2 has been recorded in the buffer corresponding to 500 us. In a case of determining that the predicted traffic amount for the time section T_x is not recorded in the buffer corresponding to the time section T_x (step S127: NO), the prediction unit 171 performs the processing from step S128.

In a case of determining that the predicted traffic amount for the time section T_x is recorded in the buffer corresponding to the time section T_x for each distributed station 13 (step S127: YES), the prediction unit 171 performs the processing from step S124. That is, the prediction unit 171 reads and sums the predicted traffic amount DU(i−T_x/T(i)+1) to the predicted traffic amount DU(i) from the buffer corresponding to the time section T_x for each distributed station 13 to obtain DU_T_x(P). For example, it is assumed that the allocation time interval T(i) is 250 us and the time section T_x is 500 us. The prediction unit 171 sums the predicted traffic amount DU(i−1) and the predicted traffic amount DU(i) to calculate DU_500 us (P).

The prediction unit 171 stores the time-series predicted traffic amounts DU_T_x(1) to DU_T_x(P−1) of each distributed station 13 calculated in the past for the time section T_x. The prediction unit 171 additionally stores the newly calculated predicted traffic amount DU_T_x(P) to the predicted traffic amounts DU_T_x(1) to DU_T_x(P−1) for each distributed station 13 (step S124). The prediction unit 171 performs the processing of step S125 and learns the traffic amount prediction model using the time-series predicted traffic amounts in the time section T_x.

After the processing of step S125 or in a case of determining NO in step S127, the prediction unit 171 determines whether or not to have selected all the K time sections T_1 to T_req to be processed (step S128). In a case where there is an unselected time section (step S128: NO), the prediction unit 171 returns to step S121 and sets a newly selected time section to T_x.

Then, in a case of determining to have selected all the K time sections to be processed (step S128: YES), the prediction unit 171 stores the traffic amount prediction model corresponding to each of the K time sections T_1 to T_req and a prediction time that is a time from when the input data is input to the traffic amount prediction model to when the output data is output (step S129).

FIG. 7 is a flowchart illustrating future traffic amount prediction processing of the prediction unit 171. FIG. 7 illustrates detailed processing in step S114 of FIG. 5. The prediction unit 171 determines whether or not the future traffic amount is predictable by time t(i+1) when the next period D(i) ends (step S131). Specifically, the prediction unit 171 determines whether or not a sum of the allocation time interval T(i) and a switching time Tc is longer than the prediction time of the traffic amount prediction model of the allocation time interval T(i).

In a case where the allocation time interval T(i)+the switching time Tc is longer than the prediction time (T(i)+Tc>the prediction time), the prediction unit 171 determines that the prediction of the future traffic amount is possible by the end of the next period D(i) (step S131: YES). The prediction unit 171 inputs p time-series predicted traffic amounts DU(P) to DU (P−p+1) from the latest one of the allocation time interval T(i) to the traffic amount prediction model created for the allocation time interval T(i) for each distributed station 13. The prediction unit 171 calculates the future traffic amount DU(i+1) of each distributed station 13 in the period D(i+1) from time t(i+1) to time t(i+2) (step S132). Note that t(i+2)=t(i+1)+T(i). The prediction unit 171 stores the calculated future traffic amount DU(i+1) of each distributed station 13.

In a case where the prediction time is equal to or longer than the allocation time T(i)+the switching time Tc (T(i)+Tc≤the prediction time), the prediction unit 171 determines that the prediction of the future traffic amount is not possible by the end of the next period D(i) (step S131: NO). The prediction unit 171 performs the prediction from time t (i+1) to the time section T_req (for example, 5 ms) ahead that satisfies a service request delay. The prediction unit 171 sums the T_req/T(i) time-series predicted traffic amounts of the allocation time interval T(i) at a time in reverse chronological order for each distributed station 13 to calculate the time-series predicted traffic amounts in the time section T_req. The prediction unit 171 inputs q time-series predicted traffic amounts from the latest one of the time sections T_req to the traffic amount prediction model created for the time section T_req for each distributed station 13. Thereby, the prediction unit 171 calculates a future traffic amount DUreq(i+1) of each distributed station 13 in the period D(i+1) from time t(i+1) to time t(i+2) (step S133). Note that t(i+2)=t(i+1)+T_req. The prediction unit 171 sets the future traffic amount DUreq(i+1) as the future traffic amount DU(i+1) calculated in step S114 of FIG. 5.

FIG. 8 is a flowchart illustrating upper link traffic amount prediction processing in the prediction unit 171. After the processing of FIG. 5, the prediction unit 171 executes the upper link traffic amount prediction processing illustrated in FIG. 8. The traffic amount of the upper link between the aggregation station 14-n and the transfer apparatus 15 is the same as the traffic amount of the aggregation station 14-n. Therefore, first, the prediction unit 171 acquires bearer information received in advance by the switching instruction apparatus 17 from the aggregation station 14 (step S141). The bearer information is used as connection information indicating connection between the upper apparatus and the lower apparatus. The prediction unit 171 acquires the connection relationship between the distributed station 13 and the aggregation station 14 on the basis of the bearer information.

For each aggregation station 14, the prediction unit 171 sums the future traffic amounts DU(i+1) of the subordinate distributed stations 13 calculated in step S114 of FIG. 5, and calculates a future traffic amount L(i+1) that is the traffic amount in the period D(i+1) of the upper link connected to the aggregation station 14 (step S142). Specifically, the prediction unit 171 calculates the following.

$$Future traffic amount L ( i + 1 ) = Σfuture traffic amount DU ( i + 1 ) \times if ( aggregation station - distributed station connection )$$

if(aggregation station−distributed station connection) is a flag that takes the value of 1 in a case where the aggregation station 14 is designated as the connection destination of the distributed station 13, and takes the value of 0 in a case where the aggregation station 14 is not designated. The prediction unit 171 outputs the period D(i+1) and the future traffic amount L(i+1) of each upper link to the switching threshold determination unit 172 and the switching determination unit 175 (step S143).

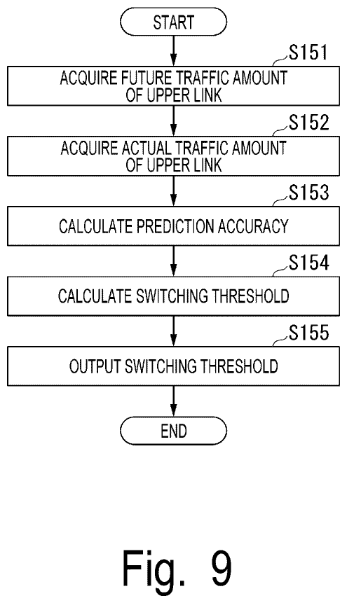

FIG. 9 is a flowchart illustrating switching threshold calculation processing in the switching threshold determination unit 172. Processing of FIG. 9 corresponds to the processing of step S4 of FIG. 4. The prediction accuracy calculation unit 173 receives information of the period D(a) and the future traffic amount L(a) of each upper link from the prediction unit 171 (step S151). These pieces of information correspond to the period D(i+1) and the future traffic amount L(i+1) of each upper link output by the prediction unit 171 in step S143 of FIG. 8.

Next, the prediction accuracy calculation unit 173 acquires the actual traffic amount of each distributed station 13 in the period D(a) (step S152). The prediction accuracy calculation unit 173 sums the actual traffic amounts in the period D(a) acquired in step S152 for the subordinate distributed stations 13 to calculate an actual traffic amount L′(a) that is the actual traffic amount of the upper link connected to the aggregation station 14 for each aggregation station 14. Note that the prediction accuracy calculation unit 173 may receive the actual traffic amount L′(a) in the period D(a) from the aggregation station 14.

The prediction accuracy calculation unit 173 acquires the link rate of each upper link. The prediction accuracy calculation unit 173 calculates the prediction accuracy in the period D(a) for each upper link (step S153). For example, the prediction accuracy calculation unit 173 calculates an error rate below as the prediction accuracy.

$$The error rate = \vert the future traffic amount L ( a ) - the actual traffic amount {L}^{′} ( a ) \vert / ( the actual traffic amount {L}^{′} ( a ) ) \times 100$$

Alternatively, the prediction accuracy calculation unit 173 may obtain a root mean squared error (RMSE) or a mean absolute error (MAE) below used for evaluating the prediction accuracy. Note that fi is the future traffic amount L(a), and yi is the actual traffic amount L′(a).

$$\begin{matrix}[ Math . 1 ] & \\ RMSE = \sqrt{\frac{1}{n} {\sum }_{k = 1}^{n} {( {f}_{i} - {y}_{i} )}^{2}} & ( 1 )\end{matrix}$$

$$\begin{matrix}[ Math . 2 ] & \\ MAE = \frac{1}{n} {Σ}_{k = 1}^{n} \vert {f}_{i} - {y}_{i} \vert & ( 2 )\end{matrix}$$

Next, the threshold calculation unit 174 calculates the switching threshold to be used in and after the period D(a) using the prediction accuracy calculated in step S153 (step S154). For example, in a case of calculating the error rate in step S153, the threshold calculation unit 174 calculates ae switching threshold TH of the upper link in the following manner.

$$Switching threshold TH = link rate \times ( 100 - error rate ) / 100 \qquad ( 3 )$$

Alternatively, in a case of calculating the RMSE or the MAE in step S153, the threshold calculation unit 174 converts a lookup table stored in advance into the error rate.

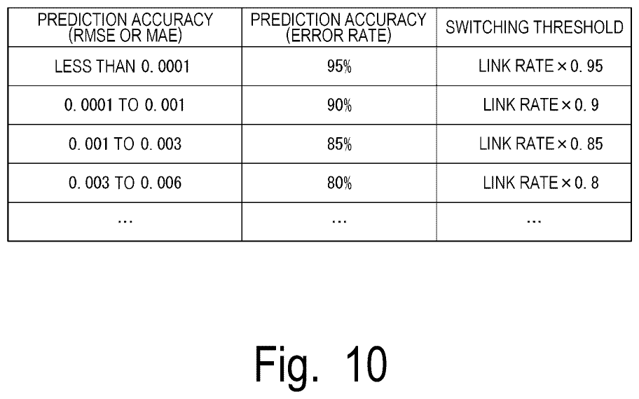

FIG. 10 is a table illustrating an example of the lookup table. The lookup table is data in which the prediction accuracy is associated with calculation formulas of the error rate and the switching threshold. The threshold calculation unit 174 reads the error rate corresponding to the prediction accuracy from the lookup table. The threshold calculation unit 174 calculates the switching threshold TH of each upper link by the above expression (3) using the read error rate.

In FIG. 9, the threshold calculation unit 174 outputs a switching threshold TH of each upper link calculated in step S154 to the switching determination unit 175 (step S155).

A degree of accuracy or the like is used to calculate the prediction accuracy. However, it is uncertain whether the accuracy is actually secured. In the present embodiment, the traffic amount is predicted in advance, and then the actual traffic flows. Therefore, as described above, the prediction accuracy is calculated using the difference between the actual traffic and the predicted traffic amount.

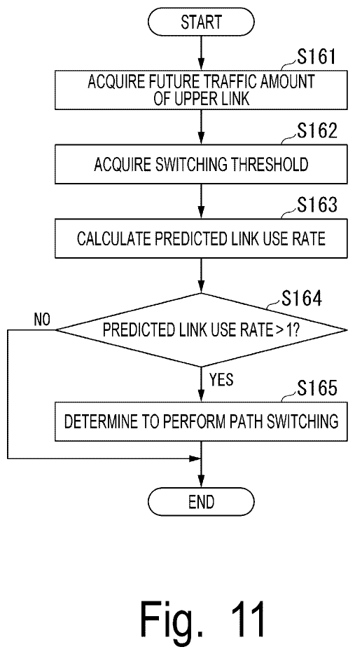

FIG. 11 is a flowchart illustrating switching determination processing in the switching determination unit 175. Processing of FIG. 11 corresponds to the processing of step S8 of FIG. 4. The switching determination unit 175 performs the processing of FIG. 11 for each upper link. The switching determination unit 175 receives the information of the period D(b) and the future traffic amount L(b) of each aggregation station 14 from the prediction unit 171 (step S161). These pieces of information correspond to the period D(i+1) and the future traffic amount L(i+1) of each aggregation station 14 output by the prediction unit 171 in step S143 of FIG. 8.

The switching determination unit 175 receives the switching threshold TH of each upper link output by the threshold calculation unit 174 in step S155 of FIG. 9 (step S162). The switching determination unit 175 calculates a predicted link use rate of each upper link by the following expression (4) using the switching threshold TH (step S163).

$$Predicted link use rate = future traffic amount L ( b ) / switching threshold TH \qquad ( 4 )$$

Note that the switching determination unit 175 converts the future traffic amount L(b) into the traffic amount per unit time equal to the link rate by, for example, dividing the future traffic amount L(b) by the length of the period D(b) before substituting the future traffic amount L(b) into the expression (4). The switching determination unit 175 determines whether or not the calculated predicted link use rate exceeds 1 (step S164). In a case of determining that the link use rate is equal to or less than 1, that is, determining that the future traffic amount is equal to or less than the switching threshold, the switching determination unit 175 terminates the processing of FIG. 11 because of the prediction that congestion does not occur. On the other hand, in a case of determining that the predicted link use rate exceeds 1, that is, determining that the future traffic amount exceeds the switching threshold, the switching determination unit 175 determines to perform the path switching because occurrence of congestion is predicted (step S165).

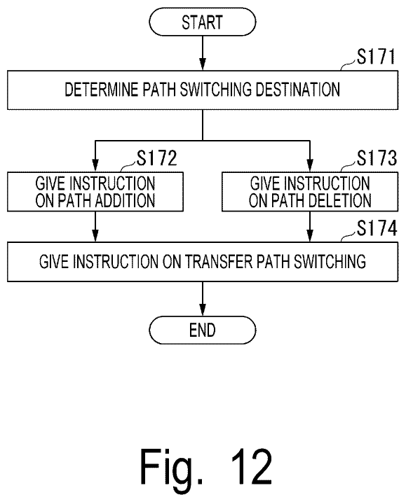

FIG. 12 is a flowchart illustrating the switching determination processing in the switching determination unit 175. In a case of determining to perform the path switching in step S165 of FIG. 11, the switching determination unit 175 starts the processing of FIG. 12.

The switching determination unit 175 acquires, from the prediction unit 171, the future traffic amount in the period D(b) of each upper link, the information of the distributed stations 13 subordinate to the aggregation station 14 connected to the upper link, and the future traffic amounts DU(b) of the distributed stations 13 in the period D(b). The switching determination unit 175 determines to switch the connection destination of one or more distributed stations 13 subordinate to the aggregation station 14 that uses the upper link having the predicted link use rate exceeding 1 to another aggregation station 14. At this time, the switching determination unit 175 determines the aggregation station 14 as the switching destination of the distributed stations 13 targeted for switching the connection destination so that the future traffic amount in each upper link becomes equal to or less than the switching threshold TH of the upper link, using the future traffic amount DU(b) of each distributed station 13 (step S171).

The switching determination unit 175 transmits a path addition instruction for adding the traffic of the distributed stations 13 targeted for switching the connection destination to the aggregation station 14 as the connection source (step S172). Further, the switching determination unit 175 transmits a path deletion instruction for deleting the traffic of the distributed stations 13 targeted for switching the connection destination to the aggregation station 14 as the switching source (step S173). Further, the switching determination unit 175 transmits a path switching instruction to instruct the transfer apparatus 15 to switch the communication path between the distributed stations 13 targeted for switching the connection destination and the aggregation station 14 as the switching source to the communication path between the distributed stations 13 targeted for switching the connection destination and the aggregation station 14 as the switching destination (step S174).

As described above, the communication system 1 and the mobile communication system 10, which are examples of the conventional communication system, predict the future traffic amount of the upper link in the period D(a), and calculate the prediction accuracy on the basis of the future traffic amount and the actual traffic amount. The communication system 1 and the mobile communication system 10 determine the switching threshold on the basis of the link rate of the upper link and the prediction accuracy. Then, the communication system 1 and the mobile communication system 10 predict the future traffic amount of the upper link in the period D(b) that is a period after the period D(a), and determine the necessity of the path switching on the basis of the switching threshold and the future traffic amount.

However, in an actual communication environment in which a plurality of flows is mixed, the prediction accuracy becomes low if the future traffic amounts of all the flows are collectively predicted. On the other hand, the calculation load related to the prediction increases and the path switching cannot be completed before congestion actually occurs if the future traffic amount is predicted for each flow. As described above, the conventional communication system cannot prevent the occurrence of congestion and may cause the communication delay even if the system performs the execution determination of the path switching on the basis of the prediction value of the traffic amount.

In contrast, a communication system in each embodiment of the present invention to be described below has a configuration capable of completing the path switching before congestion occurs. Specifically, the communication system in each embodiment performs control so that a calculation amount related to prediction of a future traffic amount falls within a range in which the path switching can be completed in advance. The communication system in each embodiment groups a plurality of flows to be predicted and predicts the future traffic amount in units of groups, thereby reducing a calculation amount. As a result, the communication system in each embodiment can suppress occurrence of congestion and reduce a communication delay while satisfying communication quality even in a general communication environment in which a plurality of flows is mixed.

### First Embodiment

Hereinafter, a communication system in a first embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the first embodiment is similar to the block diagram illustrating the functional configuration of the switching instruction apparatus 17 of the conventional communication system 1 illustrated in FIG. 3. Hereinafter, the switching instruction apparatus in the first embodiment will be referred to as a switching instruction apparatus 17a. The switching instruction apparatus 17a is, for example, an information processing apparatus such as a general-purpose computer. The switching instruction apparatus 17a of the present embodiment is different from the above-described conventional switching instruction apparatus 17 in a configuration of a prediction unit. Hereinafter, a configuration of a prediction unit 171a of the communication system in the present embodiment will be described.

### [Functional Configuration of Prediction Unit]

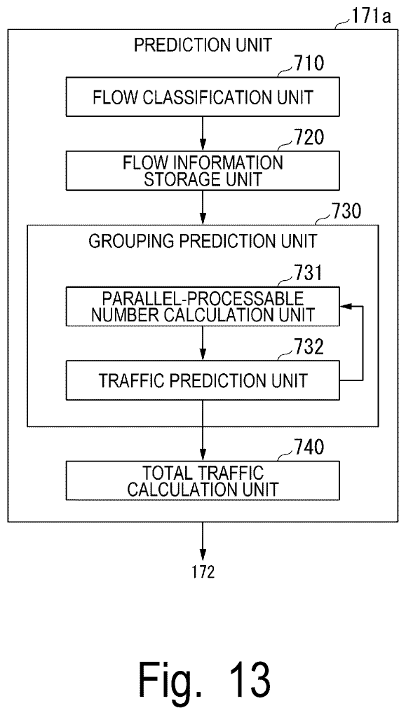

FIG. 13 is a block diagram illustrating a functional configuration of the prediction unit 171a of the communication system in the first embodiment of the present invention. As illustrated in FIG. 13, the prediction unit 171a includes a flow classification unit 710, a flow information storage unit 720, a grouping prediction unit 730, and a total traffic calculation unit 740.

The flow classification unit 710 classifies flows input to a network 5 in a predetermined period (for example, 1 millisecond, 1 second, or the like) on the basis of characteristics of traffic. Here, the flow is a flow transmitted from a lower apparatus 3 to an upper apparatus 4 via the network 5.

In addition, here, flows of the same traffic pattern are defined as one flow. The flows of the same traffic pattern are, for example, flows having the same QoS. In addition, even the flows by the same lower apparatus 3 and upper apparatus 4 are defined as different flows when the traffic patterns are different (for example, if the QoS is different).

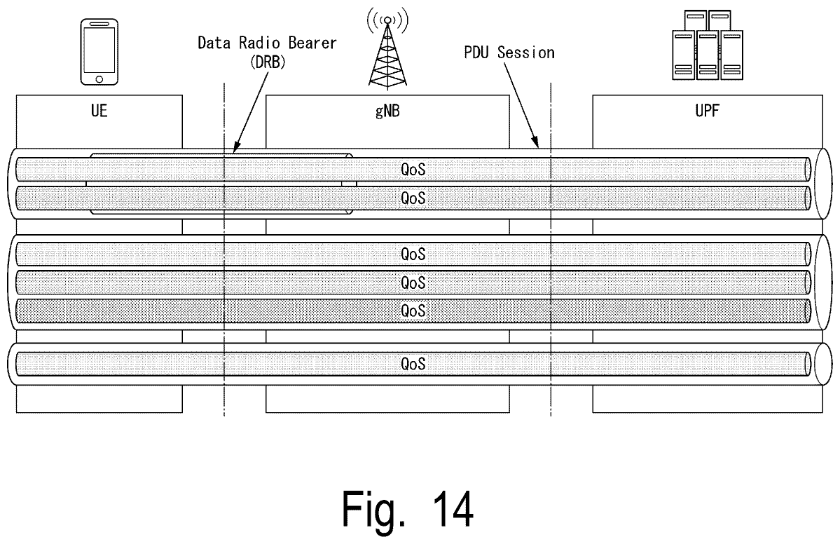

FIG. 14 is a schematic diagram for describing definition of a flow as a precondition in the first embodiment of the present invention. FIG. 14 illustrates a case where the number of terminals (UEs) that are the lower apparatuses 3 is three, and a thick cylinder represents a flow by each terminal. The flow by each terminal may include a plurality of flows of different traffic patterns (of different types of QoS).

In the top thick cylinder, flows of two types of traffic patterns are respectively represented by a thin cylinder hatched pale and a thin cylinder hatched medium pale. Further, in the middle thick cylinder, flows of three types of traffic patterns are respectively represented by a thin cylinder hatched pale, a thin cylinder hatched medium pale, and a thin cylinder hatched dark. Further, in the lower thick cylinder, only a flow of one type of traffic pattern is represented by a thin cylinder hatched pale.

For example, the thin cylinder hatched dark is moving image traffic at a frame rate of 60 frames per second (fps), the thin cylinder hatched medium pale is a flow of moving image traffic at the frame rate of 30 fps, the thin cylinder hatched pale is a flow of file transfer traffic by a file transfer protocol (FTP), and the like.

The prediction unit 171a in the present embodiment assumes that the flows of the same traffic pattern (of the same QoS) have the same flow characteristics (for example, periodicity or the like). The prediction unit 171a classifies the flows for each traffic pattern and predicts a future traffic amount.

The flow classification unit 710 classifies the flows according to the flow type based on information defined in, for example, 5G qos identifier (5QI), sub network slice selection assist information (S-NSSAI), or the like. The flow classification unit 710 calculates the number of terminals and a total value of traffic amounts for each classified flow, and stores the calculated data in a flow information table stored in the flow information storage unit 720.

The flow information storage unit 720 include a storage medium, for example, a semiconductor memory such as a random access memory (RAM), an electrically erasable programmable read only memory (EEPROM), or a read only memory (ROM), a solid state drive (SSD) flash memory, a magnetic disk such as a hard disk drive (HDD), a storage medium (not illustrated) such as an optical disk, or any combination of these storage media.

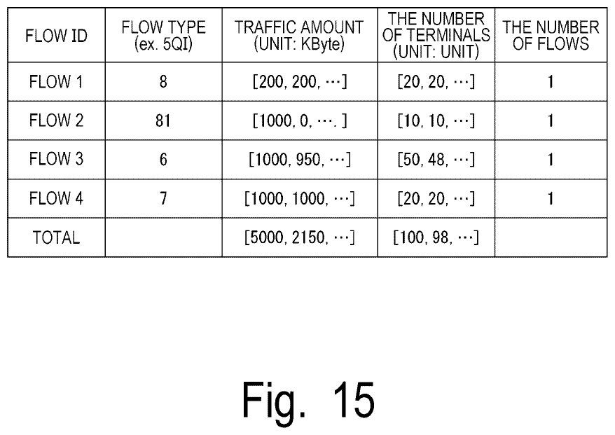

FIG. 15 is a table illustrating an example of a configuration of the flow information table in the first embodiment of the present invention. As illustrated in FIG. 15, for example, the flow information table is data in a table format in which a flow identifier (ID), a flow type, a traffic amount, the number of terminals, and the number of flows are associated with one another.

The flow ID is an identifier for identifying the classified flow. The flow type is a value representing a flow characteristic. In the flow information table illustrated in FIG. 15, a value of the flow type is a 5QI value. The traffic amount is a total value of the traffic amounts for each classified flow. In the flow information table illustrated in FIG. 15, the unit of the traffic amount is kilobytes. The number of terminals is a total value of the number of terminals for each classified flow. In the flow information table illustrated in FIG. 15, the unit of the number of terminals is unit.

The grouping prediction unit 730 calculates a parallel-processable number on the basis of a predetermined allowable delay time (hereinafter referred to as “allowable delay”) and a prediction time. The allowable delay is a delay time that is allowed to complete prediction processing before timing at which path switching is required in performing the path switching on the basis of prediction of the future traffic amount. Furthermore, the prediction time referred to here is a time required for the prediction processing of the future traffic amount. Further, the parallel-processable number referred to here is a maximum number of pieces of prediction processing that can be executed in parallel for a plurality of flows and can be completed within a range of the allowable delay.

The grouping prediction unit 730 predicts the future traffic amount while suppressing the time required for the prediction processing to a calculation amount that falls within the allowable delay by adjusting the number of pieces of prediction processing to be executed in parallel to be within the parallel-processable number. The grouping prediction unit 730 outputs the predicted value of the future traffic amount to the total traffic calculation unit 740.

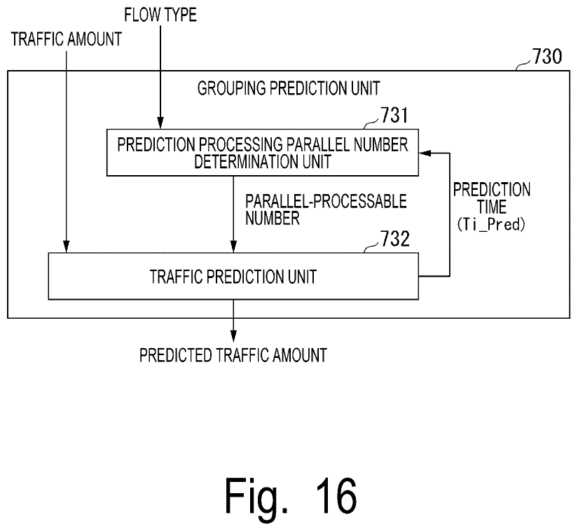

Hereinafter, the configuration of the grouping prediction unit 730 will be described in more detail. FIG. 16 is a block diagram illustrating a functional configuration of the grouping prediction unit 730 of the communication system in the first embodiment of the present invention. As illustrated in FIG. 16, the grouping prediction unit 730 includes a parallel-processable number calculation unit 731 and a traffic prediction unit 732.

The parallel-processable number calculation unit 731 specifies an allowable delay (Delay_a) of each flow on the basis of a flow ID. The parallel-processable number calculation unit 731 specifies the allowable delay (Delay_a) on the basis of, for example, information regarding 5QI or S-NSSAI stored in the storage medium (not illustrated) included in the prediction unit 171a. Note that the information regarding 5QI or S-NSSAI may be stored in the flow information storage unit 720. The above-described storage medium (not illustrated) includes, for example, semiconductor memories such as a RAM, an EEPROM, and a ROM, a flash memory such as an SSD, a magnetic disk such as an HDD, a storage medium such as an optical disk, or an arbitrary combination of these storage media.

For example, as a value of the allowable delay, a value of “packet delay budget (PDB)” can be used in a case of using the 5QI, and a value of “maximum allowed end-to-end latency” can be used in a case of using the S-NSSAI.

Note that, in a case where the flow ID is not related to the allowable delay, for example, use of an arbitrary value of the allowable delay may be determined in advance. For example, in a case of the flow ID unrelated to the allowable delay, a value such as Delay_a=10 [ms] may be determined in advance. Alternatively, in a case of using the S-NSSAI, a specified value set according to a service may be used. For example, in the case of using the S-NSSAI, a specified value such as URLLC=1 [ms] or eMbb=10 [ms] may be used. Note that, in this case, it is assumed that association between the service and the value of the allowable delay is determined in advance in the flow information table or the like.

The parallel-processable number calculation unit 731 acquires information indicating a time required for prediction (Ti_pred) (hereinafter referred to as “prediction time”) predicted by the traffic prediction unit 732. The parallel-processable number calculation unit 731 calculates a parallel-processable number (M) on the basis of the allowable delay (Delay_a) and the prediction time (Ti_pred), as given in the following expression (5).

$$M = Delay\_a / Ti\_pred \qquad ( 5 )$$

For example, if the allowable delay is 100 milliseconds (that is, Delay_a=100 [ms]) and the prediction time is 5 milliseconds (that is, Ti_pred=5 [ms]), the parallel-processable number is 20 (that is, M=20). Note that since the prediction time differs depending on the number of input data (traffic cycle) for each flow, the prediction time (Ti_pred) may be set to a maximum prediction time or an average prediction time. The parallel-processable number calculation unit 731 outputs a calculated value of the parallel-processable number (M) to the traffic prediction unit 732.

The traffic prediction unit 732 acquires the value of the parallel-processable number (M) output from the parallel-processable number calculation unit 731. The traffic prediction unit 732 narrows down the number of flows to fall within the parallel-processable number (M), and predicts the future traffic amount (hereinafter also referred to as “predicted traffic amount”). The traffic prediction unit 732 according to the present embodiment narrows down the number of flows for performing the prediction processing by randomly selecting M flows from all the classified flows.

Note that the number of selected flows may be any number as long as it is M or less. Note that since prediction accuracy of the future traffic amount decreases as the number of selected flows decreases, the number of selected flows is desirably M, which is the maximum number of flows (that is, the parallel-processable number) that can be predicted in parallel within an allowable time.

Note that, in the present embodiment, the traffic prediction unit 732 is configured to randomly select M flows, but the embodiment is not limited to this configuration. The traffic prediction unit 732 may be configured to select the M flows according to an arbitrary rule. Note that a configuration to more efficiently narrow down the number of flows will be described in another embodiment to be described below.

The traffic prediction unit 732 predicts the future traffic amounts for the selected M flows. The traffic prediction unit 732 outputs the value of the future traffic amount (predicted traffic amount) predicted for each of the M flows to the total traffic calculation unit 740.

As illustrated in FIG. 13, the total traffic calculation unit 740 acquires the value of the predicted traffic amount of each of the M flows predicted by the traffic prediction unit 732 of the grouping prediction unit 730. The total traffic calculation unit 740 adds up the acquired predicted traffic amounts to obtain a value of a total traffic amount (hereinafter referred to as “total traffic amount”). The total traffic calculation unit 740 outputs the calculated value of the total traffic amount to the switching threshold determination unit 172.

Processing after the value of the total traffic amount is output from the total traffic calculation unit 740 of the prediction unit 171a to the switching threshold determination unit 172 (that is, processing related to determination of execution of the path switching and processing related to execution control of the path switching) is similar to the processing in the conventional communication system 1, and thus description thereof is omitted. That is, processing in the subsequent stage after the processing by the prediction unit 171a is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17a in the first embodiment of the present invention classifies each of the flows input from, for example, the lower apparatus 3 in the predetermined period on the basis of the characteristic of the traffic pattern (for example, QoS) based on the information defined in, for example, the 5QI or S-NSSAI. The switching instruction apparatus 17a calculates the parallel-processable number, which is the maximum number of flows for performing pieces of the prediction processing in parallel within the range of the allowable delay, on the basis of the allowable delay and the prediction time. The switching instruction apparatus 17a randomly selects the M flows from all the classified flows input in the predetermined period, and respectively calculates the future traffic amounts (predicted traffic amounts) of the selected M flows. The switching instruction apparatus 17a adds up the predicted traffic amounts calculated for the respective selected flows, and performs execution determination and execution control of the path switching on the basis of the total traffic amount.

As described above, the switching instruction apparatus 17a in the first embodiment of the present invention narrows down the number of flows for predicting the predicted traffic amount in parallel so as to fall within the range of the parallel-processable number that enables completion of the prediction processing within the allowable time in the prediction of the path switching. As a result, the switching instruction apparatus 17a can always complete the prediction processing before the timing at which the path switching is required (that is, the timing at which congestion occurs).

Therefore, the switching instruction apparatus 17a can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17a in the first embodiment of the present invention can reduce the communication delay while satisfying the communication quality even in a case where a plurality of flows is mixed.

### Second Embodiment

Hereinafter, a communication system in a second embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the second embodiment is similar to the block diagram illustrating the functional configuration of the switching instruction apparatus 17 of the conventional communication system 1 illustrated in FIG. 3. Hereinafter, the switching instruction apparatus in the second embodiment will be referred to as a switching instruction apparatus 17b. The switching instruction apparatus 17b is, for example, an information processing apparatus such as a general-purpose computer. The switching instruction apparatus 17b of the present embodiment is different from the above-described conventional switching instruction apparatus 17 in a configuration of a prediction unit. Hereinafter, a configuration of a prediction unit 171b of the communication system in the present embodiment will be described.

### [Functional Configuration of Prediction Unit]

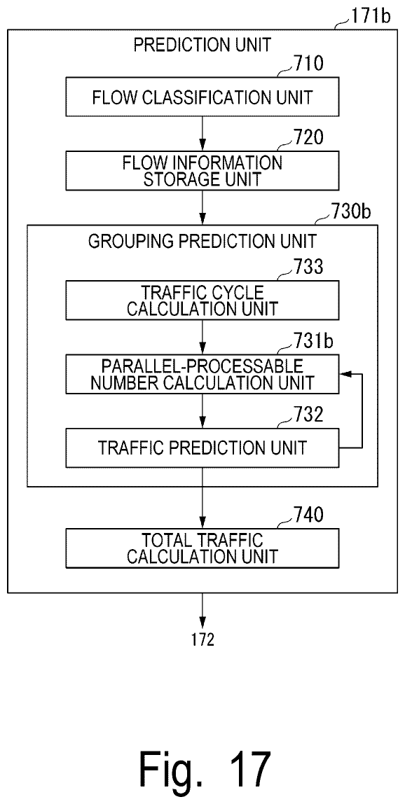

FIG. 17 is a block diagram illustrating a functional configuration of the prediction unit 171b of the communication system in a second embodiment of the present invention. As illustrated in FIG. 17, the prediction unit 171b includes a flow classification unit 710, a flow information storage unit 720, a grouping prediction unit 730b, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730b predicts a future traffic amount while suppressing a time required for prediction processing to a calculation amount that falls within an allowable delay by adjusting the number of pieces of prediction processing to be executed in parallel to be within a parallel-processable number. The grouping prediction unit 730b outputs a predicted value of the future traffic amount to the total traffic calculation unit 740.

As illustrated in FIG. 17, the grouping prediction unit 730b in the second embodiment has a configuration in which a traffic cycle calculation unit 733 is added to the above-described grouping prediction unit 730 in the first embodiment.

The traffic cycle calculation unit 733 calculates a traffic cycle of each flow. The traffic cycle calculation unit 733 outputs a calculated value of the traffic cycle of each flow to the parallel-processable number calculation unit 731b. The parallel-processable number calculation unit 731b reflects the traffic cycle calculated by the traffic cycle calculation unit 733 in a prediction time. Since the traffic cycle is reflected in the prediction time, the parallel-processable number calculation unit 731b in the second embodiment can calculate the parallel-processable number with higher accuracy than the above-described parallel-processable number calculation unit 731 in the first embodiment.

The traffic cycle calculation unit 733 specifies a traffic pattern of each flow on the basis of, for example, 5QI or S-NSSAI. The traffic cycle calculation unit 733 calculates the traffic cycle for each flow on the basis of the specified traffic pattern. Note that the traffic cycle calculation unit 733 may calculate the traffic cycle for each flow on the basis of a spectral analysis of time-series traffic.

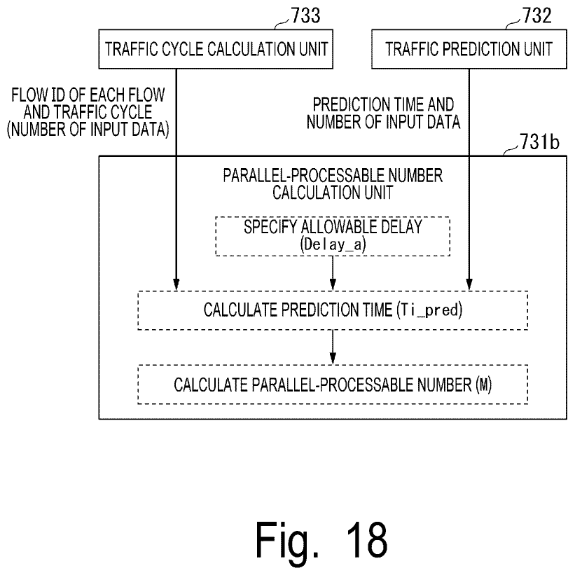

Hereinafter, the configuration of the parallel-processable number calculation unit 731b will be described in more detail. FIG. 18 is a diagram for describing a functional configuration of the parallel-processable number calculation unit 731b of the communication system in the second embodiment of the present invention.

In the present embodiment, the parallel-processable number calculation unit 731b calculates a prediction time (Ti_pred) on the basis of a processing load. Note that the present embodiment is not limited to such a configuration, and the parallel-processable number calculation unit 731b may be configured to calculate the prediction time (Ti_pred) on the basis of a time required for past prediction processing by a traffic prediction unit 732. Alternatively, the parallel-processable number calculation unit 731b may be configured to set an average value of the times required in the past prediction processing by the traffic prediction unit 732 as the prediction time (Ti_pred). Alternatively, the parallel-processable number calculation unit 731b may be configured to set a predetermined known value as the prediction time (Ti_pred).

The parallel-processable number calculation unit 731b specifies an allowable delay (Delay_a) of each flow on the basis of a flow ID. The parallel-processable number calculation unit 731b specifies the allowable delay (Delay_a) on the basis of, for example, information regarding 5QI or S-NSSAI stored in a storage medium (not illustrated) included in the prediction unit 171b. Note that the information regarding 5QI or S-NSSAI may be stored in the flow information storage unit 720.

For example, as a value of the allowable delay, a value of “packet delay budget (PDB)” can be used in a case of using the 5QI, and a value of “maximum allowed end-to-end latency” can be used in a case of using the S-NSSAI.

Note that, in a case where the flow ID is not related to the allowable delay, for example, use of an arbitrary value of the allowable delay may be determined in advance. Alternatively, in a case of using the S-NSSAI, a specified value set according to a service may be used. Note that, in this case, it is assumed that association between the service and the value of the allowable delay is determined in advance in the flow information table or the like.

The parallel-processable number calculation unit 731b acquires the value of the traffic cycle (Ti_traffic) calculated by the traffic cycle calculation unit 733. As given in the following expression (6), the parallel-processable number calculation unit 731b calculates the prediction time (Ti_pred) on the basis of the traffic cycle (Ti_traffic) (the number of input data) calculated by the traffic cycle calculation unit 733, a total processing load (Con_sum), and a processing load (Con) of the flow.

$$Ti\_pred = Ti\_traffic / Con\_sum \times Con \qquad ( 6 )$$

The parallel-processable number calculation unit 731b calculates a parallel-processable number (M) on the basis of the allowable delay (Delay_a) and the prediction time (Ti_pred), as given in the following expression (7).

$$M = Delay\_a / Ti\_pred \qquad ( 7 )$$

Note that since the number of input data (traffic cycle) differs for each flow, and the prediction time differs depending on the number of input data, the prediction time (Ti_pred) may be a maximum prediction time or an average prediction time. The parallel-processable number calculation unit 731b outputs a calculated value of the parallel-processable number (M) to the traffic prediction unit 732.

The traffic prediction unit 732 acquires the value of the parallel-processable number (M) output from the parallel-processable number calculation unit 731b. The traffic prediction unit 732 narrows down the number of flows to fall within the parallel-processable number (M), and predicts the future traffic amount (predicted traffic amount). The traffic prediction unit 732 according to the present embodiment narrows down the number of flows for performing the prediction processing by randomly selecting M flows.

Note that the number of selected flows may be any number as long as it is M or less. Note that since prediction accuracy of the future traffic amount decreases as the number of selected flows decreases, the number of selected flows is desirably M, which is the maximum number of flows (that is, the parallel-processable number) that can be predicted in parallel within an allowable time. Further, in the present embodiment, the traffic prediction unit 732 is configured to randomly select M flows, but the embodiment is not limited to this configuration. The traffic prediction unit 732 may be configured to select the M flows according to an arbitrary rule. Note that a configuration to more efficiently narrow down the number of flows will be described in another embodiment to be described below.

The traffic prediction unit 732 predicts the future traffic amounts for the selected M flows. The traffic prediction unit 732 outputs the value of the future traffic amount (predicted traffic amount) predicted for each of the M flows to the total traffic calculation unit 740.

As illustrated in FIG. 17, the total traffic calculation unit 740 acquires the value of the predicted traffic amount predicted by the traffic prediction unit 732 of the grouping prediction unit 730b. The total traffic calculation unit 740 adds up the acquired predicted traffic amounts to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171b to the switching threshold determination unit 172 (that is, processing related to determination of execution of the path switching and processing related to execution control of the path switching) is similar to the processing in the conventional communication system 1, and thus description thereof is omitted. That is, processing in the subsequent stage after the processing by the prediction unit 171b is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17b in the second embodiment of the present invention classifies each of the flows input from, for example, a lower apparatus 3 in a predetermined period on the basis of a characteristic of the traffic pattern (for example, QoS) based on information defined in, for example, the 5QI or S-NSSAI. The switching instruction apparatus 17b calculates the parallel-processable number, which is the maximum number of flows for performing pieces of the prediction processing in parallel within the range of the allowable delay, on the basis of the allowable delay and the prediction time.

Here, the switching instruction apparatus 17b in the second embodiment calculates the traffic cycle of each flow and reflects the calculated traffic cycle in the prediction time, unlike the above-described switching instruction apparatus 17a in the first embodiment. As a result, the switching instruction apparatus 17b in the second embodiment can calculate the parallel-processable number with higher accuracy than the above-described switching instruction apparatus 17a in the first embodiment.

The switching instruction apparatus 17b randomly selects the M flows from the flows input in the predetermined period, and calculates the future traffic amounts (predicted traffic amounts) of the selected M flows. The switching instruction apparatus 17b adds up the predicted traffic amounts calculated for the respective selected flows, and performs execution determination and execution control of the path switching on the basis of the total traffic amount.

As described above, the switching instruction apparatus 17b in the second embodiment of the present invention narrows down the number of flows for predicting the predicted traffic amount in parallel so as to fall within the range of the parallel-processable number that enables completion of the prediction processing within the allowable time in the prediction of the path switching. As a result, the switching instruction apparatus 17b can always complete the prediction processing before the timing at which the path switching is required (that is, the timing at which congestion occurs).

Therefore, the switching instruction apparatus 17b can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17b in the second embodiment of the present invention can reduce the communication delay while satisfying the communication quality even in a case where a plurality of flows is mixed.

### Third Embodiment

Hereinafter, a communication system in a third embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the third embodiment is similar to the block diagram illustrating the functional configuration of the switching instruction apparatus 17 of the conventional communication system 1 illustrated in FIG. 3. Hereinafter, the switching instruction apparatus in the third embodiment will be referred to as a switching instruction apparatus 17c. The switching instruction apparatus 17c is, for example, an information processing apparatus such as a general-purpose computer. The switching instruction apparatus 17c of the present embodiment is different from the above-described conventional switching instruction apparatus 17 in a configuration of a prediction unit. Hereinafter, a configuration of a prediction unit 171c of the communication system in the present embodiment will be described.

### [Functional Configuration of Prediction Unit]

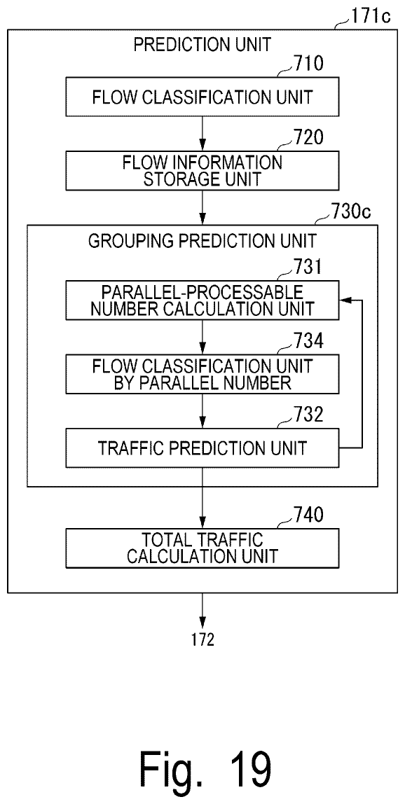

FIG. 19 is a block diagram illustrating a functional configuration of the prediction unit 171c of the communication system in the third embodiment of the present invention. As illustrated in FIG. 19, the prediction unit 171c includes a flow classification unit 710, a flow information storage unit 720, a grouping prediction unit 730c, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730c predicts a future traffic amount while suppressing a time required for prediction processing to a calculation amount that falls within an allowable delay by adjusting the number of pieces of prediction processing to be executed in parallel to be within a parallel-processable number. The grouping prediction unit 730c outputs a predicted value of the future traffic amount to the total traffic calculation unit 740.

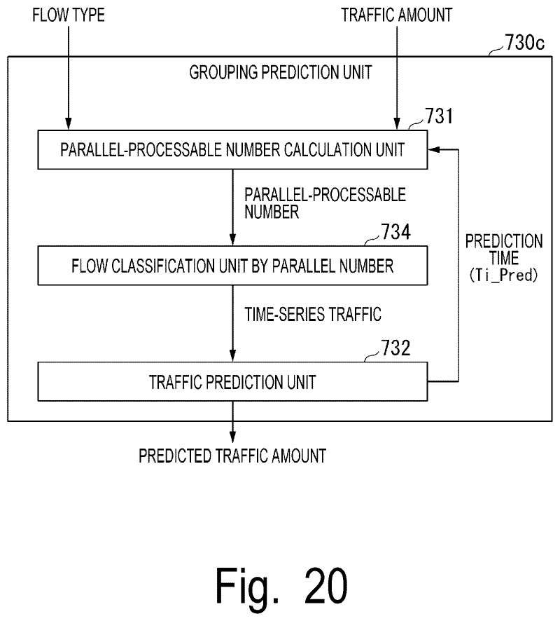

Hereinafter, the configuration of the grouping prediction unit 730c will be described in more detail. FIG. 20 is a block diagram illustrating a functional configuration of the grouping prediction unit 730c of the communication system in the third embodiment of the present invention. As illustrated in FIG. 20, the grouping prediction unit 730c includes a parallel-processable number calculation unit 731, a flow classification unit by parallel number 734, and a traffic prediction unit 732.

As illustrated in FIG. 20, the grouping prediction unit 730c in the third embodiment has a configuration in which the flow classification unit by parallel number 734 is added to the above-described grouping prediction unit 730 in the first embodiment.

The parallel-processable number calculation unit 731 specifies an allowable delay (Delay_a) of each flow on the basis of a flow ID. The parallel-processable number calculation unit 731 specifies the allowable delay (Delay_a) on the basis of, for example, the information regarding 5QI or S-NSSAI stored in a storage medium (not illustrated) included in the prediction unit 171c. Note that the information regarding 5QI or S-NSSAI may be stored in the flow information storage unit 720.

For example, as a value of the allowable delay, a value of “PDB” can be used in a case of using the 5QI, and a value of “maximum allowed end-to-end latency” can be used in a case of using the S-NSSAI. Note that, in a case where the flow ID is not related to the allowable delay, for example, use of an arbitrary value of the allowable delay may be determined in advance. Alternatively, in a case of using the S-NSSAI, a specified value set according to a service may be used. Note that, in this case, it is assumed that association between the service and the value of the allowable delay is determined in advance in the flow information table or the like.

The parallel-processable number calculation unit 731 acquires a value of a prediction time (Ti_pred) predicted by the traffic prediction unit 732. The parallel-processable number calculation unit 731 calculates a parallel-processable number (M) on the basis of the allowable delay (Delay_a) and the prediction time (Ti_pred), as given in the following expression (8).

$$M = Delay\_a / Ti\_pred \qquad ( 8 )$$

Note that since the prediction time differs depending on the number of input data (traffic cycle) for each flow, the prediction time (Ti_pred) may be set to a maximum prediction time or an average prediction time. The parallel-processable number calculation unit 731 outputs a calculated value of the parallel-processable number (M) to the flow classification unit by parallel number 734.

The flow classification unit by parallel number 734 acquires the value of the parallel-processable number (M) output from the parallel-processable number calculation unit 731. The flow classification unit by parallel number 734 compares the acquired parallel-processable number (M) with the actual number of flows.

In a case where the number of flows is equal to or less than the parallel-processable number (M), the prediction processing is completed within an allowable time even if pieces of the prediction processing for the future traffic amount are executed in parallel for all the flows. Therefore, in the case where the number of flows is equal to or less than the parallel-processable number (M), the flow classification unit by parallel number 734 does not need to perform the processing for causing the number of flows to be within the parallel-processable number, and thus does not perform processing of selecting only some flows from all the flows, processing of grouping a plurality of flows into one flow, or the like.

On the other hand, in a case where the number of flows is larger than the parallel-processable number (M), the prediction processing is not completed within the allowable time if pieces of the prediction processing for the future traffic amount are executed in parallel for all the flows. This causes congestion and causes a communication delay. Therefore, in the case where the number of flows is larger than the parallel-processable number (M), the flow classification unit by parallel number 734 groups the flows so that the number of flows becomes the same as the parallel-processable number.

The above-described grouping prediction unit 730 in the first embodiment and the above-described grouping prediction unit 730b in the second embodiment have been configured to select some flows (that is, corresponding to the parallel-processable number (M)) from all the flows classified by the flow classification unit 710 and have performed the prediction processing for the future traffic amount only for the selected flows in the case where the number of flows is larger than the parallel-processable number (M).

In contrast, in the case where the number of flows is larger than the parallel-processable number (M), the grouping prediction unit 730c in the third embodiment performs grouping for all the flows classified by the flow classification unit 710 so that the number of flows becomes the same as the parallel-processable number, and performs the prediction processing for the future traffic amount in units of groups. Therefore, according to the grouping prediction unit 730c in the third embodiment, since the prediction processing is performed for all the flows classified by the flow classification unit 710, it is considered to be able to predict the future traffic amount with higher accuracy than the above-described grouping prediction unit 730 in the first embodiment and the above-described grouping prediction unit 730b in the second embodiment.

An arbitrary method can be used for the flow grouping processing (classification processing) by the flow classification unit by parallel number 734. The flow classification unit by parallel number 734 sums values of traffic amounts of the flows classified into the same group, and generates traffic in time-series (hereinafter referred to as “time-series traffic”). The generated time-series traffic is regarded as one flow.

For example, in a case where the actual number of flows is larger by 1 than the parallel-processable number (M), the flow classification unit by parallel number 734 arbitrarily selects two flows from all the flows. The flow classification unit by parallel number 734 sums the values of the traffic amounts of the selected two flows to generate one time-series traffic.

The flow classification unit by parallel number 734 outputs the time-series traffic of the grouped one flow and the value of the parallel-processable number (M) acquired from the parallel-processable number calculation unit 731 to the traffic prediction unit 732.

The traffic prediction unit 732 acquires the time-series traffic of the grouped one flow output from the flow classification unit by parallel number 734 and the value of the parallel-processable number (M). The traffic prediction unit 732 predicts the future traffic amount for each flow adjusted to have the same number as the parallel-processable number (M) by the flow classification unit by parallel number 734. The traffic prediction unit 732 outputs a value of the future traffic amount (predicted traffic amount) predicted for each of the M flows to the total traffic calculation unit 740.

As illustrated in FIG. 19, the total traffic calculation unit 740 acquires the value of the predicted traffic amount predicted by the traffic prediction unit 732 of the grouping prediction unit 730c. The total traffic calculation unit 740 adds up the acquired predicted traffic amounts to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171c to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171c is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

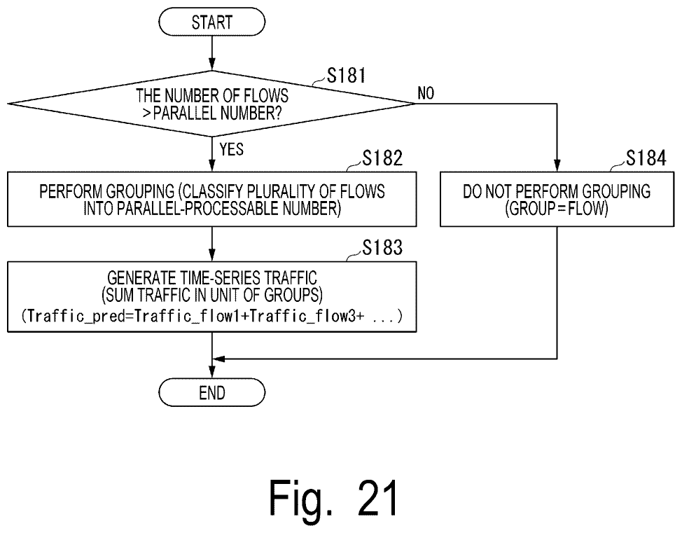

Hereinafter, an example of an operation of the grouping prediction unit 730c will be described. FIG. 21 is a flowchart illustrating an operation of the grouping prediction unit 730c of the communication system in the third embodiment of the present invention. The operation of the grouping prediction unit 730c illustrated in the flowchart of FIG. 21 is started when, for example, information used by the parallel-processable number calculation unit 731 (for example, information indicating the flow ID and the traffic amount) is stored in the flow information storage unit 720.

The parallel-processable number calculation unit 731 acquires the information necessary for calculating the future traffic amount (for example, the information indicating the flow ID and the traffic) from the flow information storage unit 720. The parallel-processable number calculation unit 731 specifies an allowable delay (Delay_a) of each flow on the basis of a flow ID. The parallel-processable number calculation unit 731 acquires a value of a prediction time (Ti_pred) predicted by the traffic prediction unit 732. The parallel-processable number calculation unit 731 calculates the parallel-processable number (M) on the basis of the allowable delay (Delay_a) and the prediction time (Ti_pred). The prediction time (Ti_pred) may be a maximum prediction time or an average prediction time. The parallel-processable number calculation unit 731 outputs a calculated value of the parallel-processable number (M) to the flow classification unit by parallel number 734.

The flow classification unit by parallel number 734 acquires the value of the parallel-processable number (M) output from the parallel-processable number calculation unit 731. The flow classification unit by parallel number 734 compares the acquired parallel-processable number (M) with the actual number of flows (step S181).

In the case where the number of flows is equal to or less than the parallel-processable number (M) (step S181: No), the flow classification unit by parallel number 734 does not need to perform the processing for causing the number of flows to be within the parallel-processable number, and thus does not perform processing of grouping a plurality of flows into one flow, or the like (step S184).

On the other hand, in the case where the number of flows is larger than the parallel-processable number (M) (step S181: Yes), the flow classification unit by parallel number 734 groups the flows so that the number of flows becomes the same as the parallel-processable number (step S182).

The flow classification unit by parallel number 734 sums values of traffic amounts of the flows classified into the same group, and generates traffic in time-series (hereinafter referred to as “time-series traffic”) (step S183). The generated time-series traffic is regarded as one flow. The flow classification unit by parallel number 734 outputs the time-series traffic of the grouped one flow and the value of the parallel-processable number (M) acquired from the parallel-processable number calculation unit 731 to the traffic prediction unit 732.

Thus, the operation of the grouping prediction unit 730c illustrated in the flowchart of FIG. 21 ends.

As described above, the switching instruction apparatus 17c in the third embodiment of the present invention classifies each of the flows input from, for example, a lower apparatus 3 in a predetermined period on the basis of a characteristic of a traffic pattern (for example, QoS) based on information defined in, for example, the 5QI or S-NSSAI. The switching instruction apparatus 17c calculates the parallel-processable number, which is the maximum number of flows that allows pieces of the prediction processing to be performed in parallel within the range of the allowable delay, on the basis of the allowable delay and the prediction time.

Then, in a case where the number of classified flows is larger than the parallel, the switching instruction apparatus 17c in the third embodiment groups the flows so that the number of flows becomes the same as the parallel-processable number, and calculates the future traffic amount in units of group. The switching instruction apparatus 17c adds up the predicted traffic amounts of the flows calculated in units of group, and performs execution determination and execution control of path switching on the basis of the calculated total traffic amount.

As described above, the switching instruction apparatus 17c in the third embodiment of the present invention narrows down the number of flows for predicting the predicted traffic amount in parallel so as to fall within the range of the parallel-processable number that enables completion of the prediction processing within the allowable time in the prediction of the path switching. As a result, the switching instruction apparatus 17c can always complete the prediction processing before the timing at which the path switching is required (that is, the timing at which congestion occurs).

Therefore, the switching instruction apparatus 17c can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17c in the third embodiment of the present invention can reduce the communication delay while satisfying the communication quality even in a case where a plurality of flows is mixed.

### Fourth Embodiment

Hereinafter, a communication system in a fourth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the fourth embodiment is similar to the block diagram illustrating the functional configuration of the switching instruction apparatus 17 of the conventional communication system 1 illustrated in FIG. 3. Hereinafter, the switching instruction apparatus in the fourth embodiment will be referred to as a switching instruction apparatus 17d. The switching instruction apparatus 17d is, for example, an information processing apparatus such as a general-purpose computer. The switching instruction apparatus 17d of the present embodiment is different from the above-described conventional switching instruction apparatus 17 in a configuration of a prediction unit. Hereinafter, a configuration of a prediction unit 171d of the communication system in the present embodiment will be described.

### [Functional Configuration of Prediction Unit]

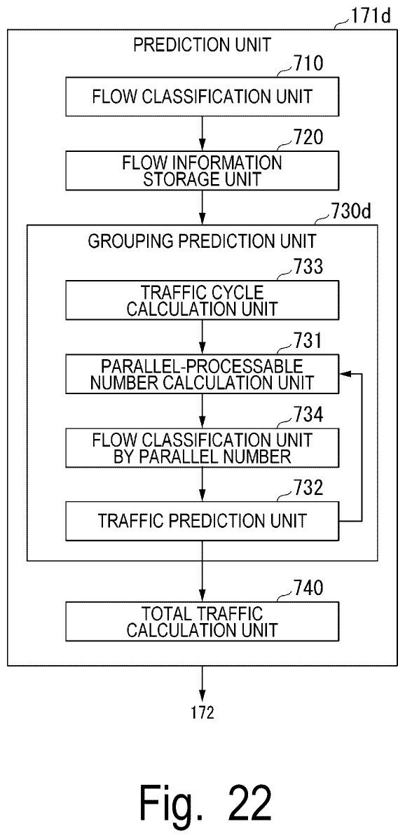

FIG. 22 is a block diagram illustrating a functional configuration of the prediction unit 171d of the communication system in a fourth embodiment of the present invention. As illustrated in FIG. 22, the prediction unit 171d includes a flow classification unit 710, a flow information storage unit 720, a grouping prediction unit 730d, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730d predicts a future traffic amount while suppressing a time required for prediction processing to a calculation amount that falls within an allowable delay by adjusting the number of pieces of prediction processing to be executed in parallel to be within a parallel-processable number. The grouping prediction unit 730d outputs a predicted value of the future traffic amount to the total traffic calculation unit 740.

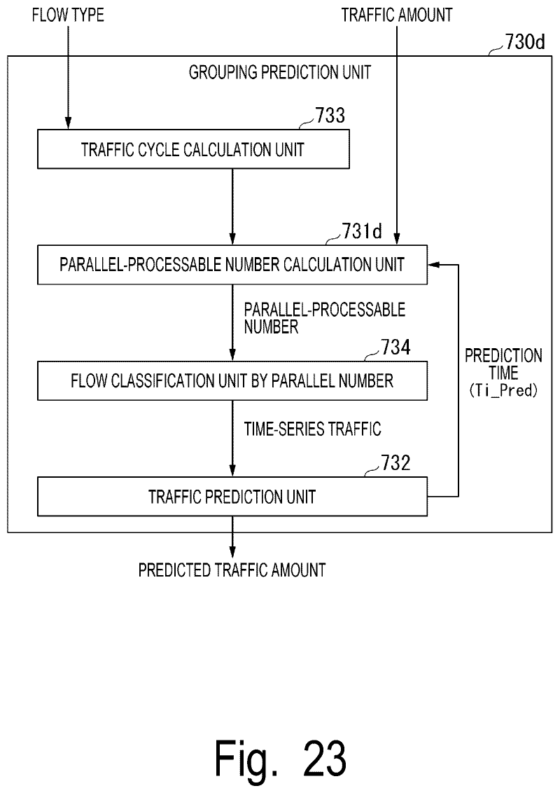

Hereinafter, the configuration of the grouping prediction unit 730d will be described in more detail. FIG. 23 is a block diagram illustrating a functional configuration of the grouping prediction unit 730d of the communication system in the fourth embodiment of the present invention. As illustrated in FIG. 23, the grouping prediction unit 730d includes a traffic cycle calculation unit 733, a parallel-processable number calculation unit 731, a flow classification unit by parallel number 734, and a traffic prediction unit 732.

As illustrated in FIG. 23, the grouping prediction unit 730d in the fourth embodiment has a configuration in which the traffic cycle calculation unit 733 and the flow classification unit by parallel number 734 are added to the above-described grouping prediction unit 730 in the first embodiment.

The traffic cycle calculation unit 733 calculates a traffic cycle of each flow. The traffic cycle calculation unit 733 outputs a calculated value of the traffic cycle of each flow to the parallel-processable number calculation unit 731d. The parallel-processable number calculation unit 731d reflects the traffic cycle calculated by the traffic cycle calculation unit 733 in a prediction time. Since the traffic cycle is reflected in the prediction time, the parallel-processable number calculation unit 731d in the fourth embodiment can calculate the parallel-processable number with higher accuracy than the above-described parallel-processable number calculation unit 731 in the first embodiment.

The traffic cycle calculation unit 733 specifies a traffic pattern of each flow on the basis of, for example, 5QI or S-NSSAI. The traffic cycle calculation unit 733 calculates the traffic cycle for each flow on the basis of the specified traffic pattern. Note that the traffic cycle calculation unit 733 may calculate the traffic cycle for each flow on the basis of a spectral analysis of time-series traffic.

The parallel-processable number calculation unit 731d specifies an allowable delay (Delay_a) of each flow on the basis of a flow ID. The parallel-processable number calculation unit 731d specifies the allowable delay (Delay_a) on the basis of, for example, the information regarding 5QI or S-NSSAI stored in a storage medium (not illustrated) included in the prediction unit 171d. Note that the information regarding 5QI or S-NSSAI may be stored in the flow information storage unit 720.

For example, as a value of the allowable delay, a value of “PDB” can be used in a case of using the 5QI, and a value of “maximum allowed end-to-end latency” can be used in a case of using the S-NSSAI. Note that, in a case where the flow ID is not related to the allowable delay, for example, use of an arbitrary value of the allowable delay may be determined in advance. Alternatively, in a case of using the S-NSSAI, a specified value set according to a service may be used. Note that, in this case, it is assumed that association between the service and the value of the allowable delay is determined in advance in the flow information table or the like.

The parallel-processable number calculation unit 731d acquires a value of a traffic cycle (Ti_traffic) calculated by the traffic cycle calculation unit 733. As given in the following expression (9), the parallel-processable number calculation unit 731d calculates a prediction time (Ti_pred) on the basis of the traffic cycle (Ti_traffic) (the number of input data) calculated by the traffic cycle calculation unit 733, a total processing load (Con_sum), and a processing load (Con) of the flow.

$$Ti\_pred = Ti\_traffic / Con\_sum \times Con \qquad ( 9 )$$

The parallel-processable number calculation unit 731d calculates a parallel-processable number (M) on the basis of the allowable delay (Delay_a) and the prediction time (Ti_pred), as given in the following expression (10).

$$M = Delay\_a / Ti\_pred \qquad ( 10 )$$

Note that since the number of input data (traffic cycle) differs for each flow, and the prediction time differs depending on the number of input data, the prediction time (Ti_pred) may be a maximum prediction time or an average prediction time. The parallel-processable number calculation unit 731d outputs a calculated value of the parallel-processable number (M) to the flow classification unit by parallel number 734.

The flow classification unit by parallel number 734 acquires the value of the parallel-processable number (M) output from the parallel-processable number calculation unit 731d. The flow classification unit by parallel number 734 compares the acquired parallel-processable number (M) with the actual number of flows.

In a case where the number of flows is equal to or less than the parallel-processable number (M), the prediction processing is completed within an allowable time even if pieces of the prediction processing for the future traffic amount are executed in parallel for all the flows. Therefore, in the case where the number of flows is equal to or less than the parallel-processable number (M), the flow classification unit by parallel number 734 does not need to perform the processing for causing the number of flows to be within the parallel-processable number, and thus does not perform processing of selecting only some flows from all the flows, processing of grouping a plurality of flows into one flow, or the like.

On the other hand, in a case where the number of flows is larger than the parallel-processable number (M), the prediction processing is not completed within the allowable time if pieces of the prediction processing for the future traffic amount are executed in parallel for all the flows. This causes congestion and causes a communication delay. Therefore, in the case where the number of flows is larger than the parallel-processable number (M), the flow classification unit by parallel number 734 groups the flows so that the number of flows becomes the same as the parallel-processable number.

The above-described grouping prediction unit 730 in the first embodiment and the above-described grouping prediction unit 730b in the second embodiment have been configured to select some flows (that is, corresponding to the parallel-processable number (M)) from all the flows classified by the flow classification unit 710 and have performed the prediction processing for the future traffic amount only for the selected flows in the case where the number of flows is larger than the parallel-processable number (M).

In contrast, in the case where the number of flows is larger than the parallel-processable number (M), the grouping prediction unit 730d in the fourth embodiment performs grouping for all the flows classified by the flow classification unit 710 so that the number of flows becomes the same as the parallel-processable number, and performs the prediction processing for the future traffic amount in units of groups. Therefore, according to the grouping prediction unit 730d in the fourth embodiment, since the prediction processing is performed for all the flows classified by the flow classification unit 710, it is considered to be able to predict the future traffic amount with higher accuracy than the above-described grouping prediction unit 730 in the first embodiment and the above-described grouping prediction unit 730b in the second embodiment.

An arbitrary method can be used for the flow grouping processing (classification processing) by the flow classification unit by parallel number 734. The flow classification unit by parallel number 734 sums values of traffic amounts of the flows classified into the same group to generate time-series traffic. The generated time-series traffic is regarded as one flow.

For example, in a case where the actual number of flows is larger by 1 than the parallel-processable number (M), the flow classification unit by parallel number 734 arbitrarily selects two flows from all the flows. The flow classification unit by parallel number 734 sums the values of the traffic amounts of the selected two flows to generate one time-series traffic.

The flow classification unit by parallel number 734 outputs the time-series traffic of the grouped one flow and the value of the parallel-processable number (M) acquired from the parallel-processable number calculation unit 731 to the traffic prediction unit 732.

The traffic prediction unit 732 acquires the time-series traffic of the grouped one flow output from the flow classification unit by parallel number 734 and the value of the parallel-processable number (M). The traffic prediction unit 732 predicts the future traffic amount for each flow adjusted to have the same number as the parallel-processable number (M) by the flow classification unit by parallel number 734. The traffic prediction unit 732 outputs a value of the future traffic amount (predicted traffic amount) predicted for each of the M flows to the total traffic calculation unit 740.

As illustrated in FIG. 22, the total traffic calculation unit 740 acquires the value of the predicted traffic amount predicted by the traffic prediction unit 732 of the grouping prediction unit 730c. The total traffic calculation unit 740 adds up the acquired predicted traffic amounts to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171d to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171d is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

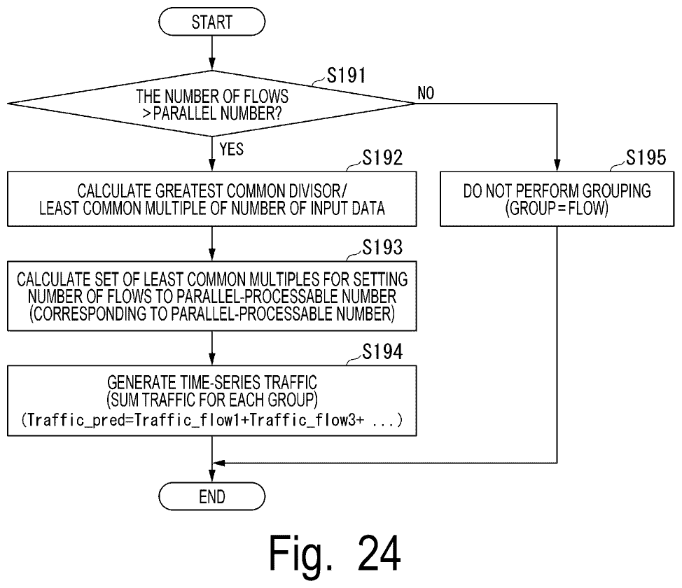

Hereinafter, an example of an operation of the grouping prediction unit 730d will be described. FIG. 24 is a flowchart illustrating an operation of the grouping prediction unit 730d of the communication system in the fourth embodiment of the present invention. The operation of the grouping prediction unit 730d illustrated in the flowchart of FIG. 24 is started when, for example, information used by the traffic cycle calculation unit 733 (for example, information indicating the flow type) and information used by the parallel-processable number calculation unit 731 (for example, information indicating the traffic amount) are stored in the flow information storage unit 720.

The traffic cycle calculation unit 733 acquires the information (for example, the flow type or the like) necessary for calculating the future traffic amount from the flow information storage unit 720. The traffic cycle calculation unit 733 specifies the traffic pattern of each flow on the basis of, for example, 5QI or S-NSSAI. The traffic cycle calculation unit 733 calculates the traffic cycle for each flow on the basis of the specified traffic pattern. The traffic cycle calculation unit 733 outputs a calculated value of the traffic cycle of each flow to the parallel-processable number calculation unit 731d.

The parallel-processable number calculation unit 731d acquires the information necessary for calculating the future traffic amount (for example, the information indicating the traffic) from the flow information storage unit 720. The parallel-processable number calculation unit 731d specifies the allowable delay (Delay_a) on the basis of, for example, the information regarding 5QI or S-NSSAI stored in a storage medium (not illustrated) included in the prediction unit 171d.

Further, the parallel-processable number calculation unit 731d acquires a value of a traffic cycle (Ti_traffic) for each flow calculated by the traffic cycle calculation unit 733. The parallel-processable number calculation unit 731d calculates the prediction time (Ti_pred) on the basis of the traffic cycle (Ti_traffic) (the number of input data) calculated by the traffic cycle calculation unit 733, the total processing load (Con_sum), and the processing load (Con) of the flow.

Then, the parallel-processable number calculation unit 731d calculates the parallel-processable number (M) on the basis of the allowable delay (Delay_a) and the prediction time (Ti_pred). The parallel-processable number calculation unit 731d outputs the calculated value of the parallel-processable number (M) to the flow classification unit by parallel number 734.

The flow classification unit by parallel number 734 acquires the value of the parallel-processable number (M) output from the parallel-processable number calculation unit 731. The flow classification unit by parallel number 734 compares the acquired parallel-processable number (M) with the actual number of flows (step S191).

In the case where the number of flows is equal to or less than the parallel-processable number (M) (step S191: No), the flow classification unit by parallel number 734 does not need to perform the processing for setting the number of flows to be within the parallel-processable number, and thus does not perform processing of grouping a plurality of flows into one flow, or the like (step S195).

On the other hand, in a case where the number of flows is larger than the parallel-processable number (M) (step S191: Yes), the flow classification unit by parallel number 734 groups the flows so that the number of flows becomes the same as the parallel-processable number. Specifically, for the purpose of grouping the flows so as to reduce the calculation amount required for the prediction processing for the future traffic amount, the flow classification unit by parallel number 734 groups the flows so that the number of input data is reduced (that is, the traffic cycle becomes short).

First, the flow classification unit by parallel number 734 calculates a greatest common divisor of the values of the number of input data (traffic cycle) for each flow. Next, the flow classification unit by parallel number 734 calculates a least common multiple that satisfies the calculated greatest common divisor (step S192).

Next, since there is a possibility that it is not enough just to perform the processing of step S192 because the number of flows is not reduced to be within the parallel-processable number, the flow classification unit by parallel number 734 calculates a set of the least common multiples for setting the number of flows to be within the parallel-processable number from among a plurality of the above calculated least common multiples (step S193). The flow classification unit by parallel number 734 groups the flows by setting each calculated set of the least common multiples of the number of input data (traffic cycles) as one group. Note that the operations of steps S192 and S193 by the flow classification unit by parallel number 734 will be described in more detail below with specific examples.

The flow classification unit by parallel number 734 sums the values of the traffic amounts of the flows classified into the same group to generate the time-series traffic (step S194). The generated time-series traffic is regarded as one flow. The flow classification unit by parallel number 734 outputs the time-series traffic of the grouped one flow and the value of the parallel-processable number (M) acquired from the parallel-processable number calculation unit 731 to the traffic prediction unit 732.

Thus, the operation of the grouping prediction unit 730d illustrated in the flowchart of FIG. 24 ends.

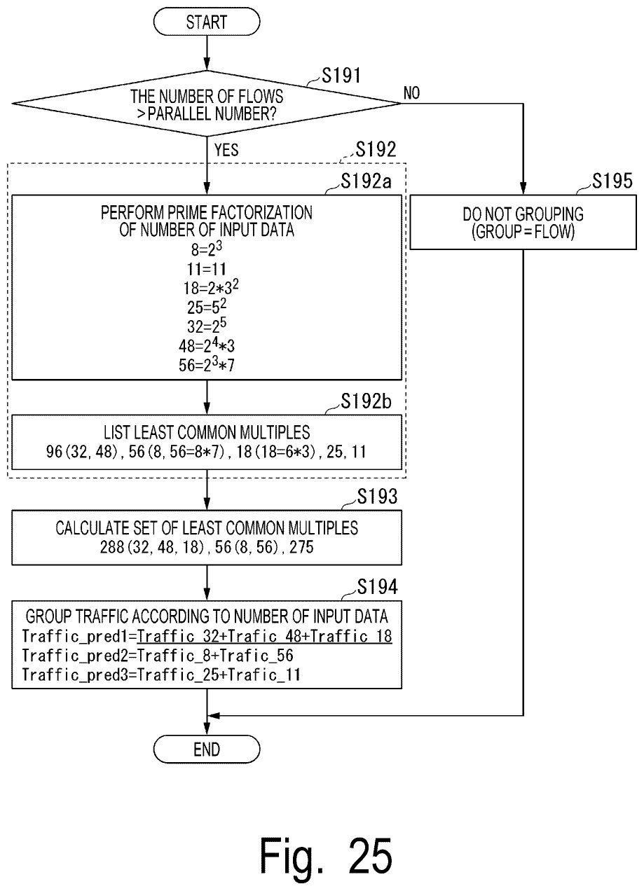

Hereinafter, the processing of steps S192 and S193 of the flowchart illustrated in FIG. 24 will be specifically described with specific numerical values. FIG. 25 is a flowchart illustrating the operation of the grouping prediction unit 730d of the communication system in the fourth embodiment of the present invention.

The flow classification unit by parallel number 734 specifies a flow having a relatively large calculation amount in the prediction processing for the future traffic amount on the basis of the traffic cycle for each flow and the parallel-processable number, and groups the flows such that the traffic cycle is minimized according to the parallel-processable number. Then, the flow classification unit by parallel number 734 sums the predicted traffic amounts for each group to generate the time-series traffic for each group, and outputs the generated time-series traffic to the traffic prediction unit 732.

In a case where the number of flows is larger than the parallel-processable number (M) (step S191: Yes), the flow classification unit by parallel number 734 groups the flows so that the number of flows becomes the same as the parallel-processable number. Specifically, first, the flow classification unit by parallel number 734 calculates the greatest common divisor of the values of the number of input data (traffic cycles) for each flow. Next, the flow classification unit by parallel number 734 lists the least common multiple that satisfies the calculated greatest common divisor (step S192).

Here, as an example, it is assumed that the number of flows is seven and the parallel-processable number is three (M=3). In addition, it is assumed that the traffic cycles (the numbers of input data) of these seven flows are 8, 11, 18, 25, 32, 48, and 56, respectively.

The flow classification unit by parallel number 734 first performs prime factorization for the value of the traffic cycle of each flow as follows (step S192a).

$$8 = {2}^{3}$$

$$11 = 11$$

$$18 = 2 \times {3}^{2}$$

$$25 = {5}^{2}$$

$$32 = {2}^{5}$$

$$48 = {2}^{4} \times 3$$

$$56 = {2}^{3} \times 7$$

The flow classification unit by parallel number 734 calculates the greatest common divisor of the value of the traffic cycle of each flow on the basis of the result of the prime factorization. The greatest common divisors calculated by the flow classification unit by parallel number 734 are, for example, as follows.

The greatest common divisors: 16 (32, 48), 8 (8, 56=8×7, 32, 48), 6 (18=6×3, 48), none (25, 11)

The flow classification unit by parallel number 734 lists the least common multiple in order from the value of the traffic cycle having the larger greatest common divisor among the calculated greatest common divisors and enumerates the calculated least common multiples (step S192b). The least common multiples listed by the flow classification unit by parallel number 734 are, for example, as follows.

The least common multiples: 96 (32, 48), 56 (8, 56=8×7), 18 (18=6×3), 25, 11

There is a possibility that it is not enough just to perform the processing of step S192 because the number of flows is not reduced to be within the parallel-processable number. In the above specific example, in a case where the listed least common multiple is set as the traffic cycle of each of the grouped flows, the listed least common multiples are five, and thus the number of flows is narrowed down from the initial seven to five at this time point. However, at this time point, the number of flows is still larger than the parallel-processable number (three).

In this case, the flow classification unit by parallel number 734 calculates a set of least common multiples for causing the number of flows to be within the parallel-processable number from among the plurality of least common multiples listed above. The flow classification unit by parallel number 734 groups the flows by setting each calculated set of the least common multiples of the number of input data (traffic cycles) as one group.

For example, to cause the number of flows to be the same as the parallel-processable number (three), the flow classification unit by parallel number 734 further calculates a set of least common multiples by multiplying relatively small values among the listed values of the least common multiples (step S193). The sets of least common multiples calculated by the flow classification unit by parallel number 734 are, for example, as follows.
288 (32, 48, 18), 56 (8, 56), 275

The values of traffic amounts of the flows classified into the same group are summed to generate the time-series traffic. The flow classification unit by parallel number 734 groups the flows according to the traffic cycle (the number of input data) and sums the traffic amounts of the flows belonging to the same group to generate the time-series traffic (step S194). The generated time-series traffic is regarded as one flow. Pieces of the time-series traffic generated by the flow classification unit by parallel number 734 are, for example, as follows.

$$Traffic\_pred1 = Traffic\_ 32 + Trafic\_ 48 + Traffic\_ 18$$

$$Traffic\_pred2 = Traffic\_ 8 + Trafic\_ 56$$

$$Traffic\_pred3 = Traffic\_ 25 + Trafic\_ 11$$

For example, the predicted traffic amount (Traffic_pred1) of the grouped first flow is a value obtained by adding up the traffic amount of the flow whose traffic cycle is 32, the traffic amount of the flow whose traffic cycle is 48, and the traffic amount of the flow whose traffic cycle is 18 as described above.

The flow classification unit by parallel number 734 outputs the time-series traffic of the grouped one flow and the value of the parallel-processable number (M) acquired from the parallel-processable number calculation unit 731 to the traffic prediction unit 732.

As described above, the switching instruction apparatus 17d in the fourth embodiment of the present invention classifies each of the flows input from, for example, a lower apparatus 3 in a predetermined period on the basis of a characteristic of the traffic pattern (for example, QoS) based on information defined in, for example, the 5QI or S-NSSAI. The switching instruction apparatus 17d calculates the parallel-processable number, which is the maximum number of flows that allows the prediction processing to be performed in parallel within the range of the allowable delay, on the basis of the allowable delay and the prediction time.

Here, the switching instruction apparatus 17d in the fourth embodiment calculates the traffic cycle of each flow and reflects the calculated traffic cycle in the prediction time, unlike the above-described switching instruction apparatus 17a in the first embodiment and the switching instruction apparatus 17c in the third embodiment. Thereby, the switching instruction apparatus 17d in the fourth embodiment can calculate the parallel-processable number with higher accuracy than the above-described switching instruction apparatus 17a in the first embodiment and the above-described switching instruction apparatus 17c in the third embodiment.

Then, in a case where the number of classified flows is larger than the parallel, the switching instruction apparatus 17d in the fourth embodiment groups the flows so that the number of flows becomes the same as the parallel-processable number, and calculates the future traffic amount in units of group. The switching instruction apparatus 17d adds up the predicted traffic amounts of the flows calculated in units of group, and performs execution determination and execution control of path switching on the basis of the calculated total traffic amount.

As described above, the switching instruction apparatus 17d in the fourth embodiment of the present invention narrows down the number of flows for predicting the predicted traffic amount in parallel so as to fall within the range of the parallel-processable number that enables completion of the prediction processing within the allowable time in the prediction of the path switching. As a result, the switching instruction apparatus 17d can always complete the prediction processing before the timing at which the path switching is required (that is, the timing at which congestion occurs).

Therefore, the switching instruction apparatus 17d can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17d in the fourth embodiment of the present invention can reduce the communication delay while satisfying the communication quality even in a case where a plurality of flows is mixed.

### Fifth Embodiment

Hereinafter, a communication system in a fifth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the fifth embodiment is similar to the block diagram illustrating the functional configuration of the switching instruction apparatus 17 of the conventional communication system 1 illustrated in FIG. 3. Hereinafter, the switching instruction apparatus in the fifth embodiment will be referred to as a switching instruction apparatus 17e. The switching instruction apparatus 17e is, for example, an information processing apparatus such as a general-purpose computer. The switching instruction apparatus 17e of the present embodiment is different from the above-described conventional switching instruction apparatus 17 in a configuration of a prediction unit. Hereinafter, a configuration of a prediction unit 171e of the communication system in the present embodiment will be described.

### [Functional Configuration of Prediction Unit]

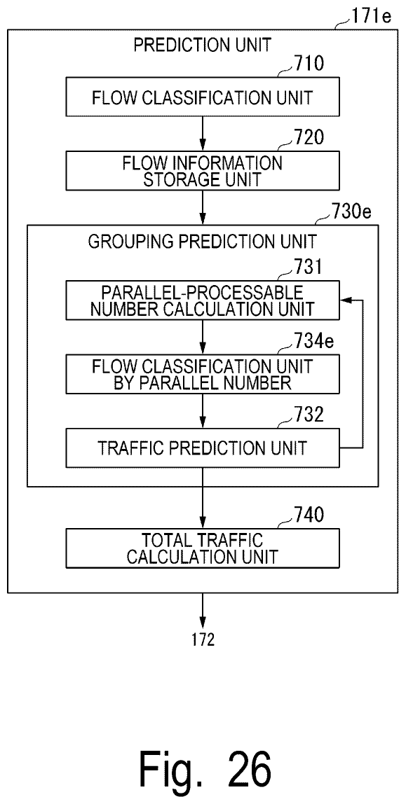

FIG. 26 is a block diagram illustrating a functional configuration of the prediction unit 171e of the communication system in a fifth embodiment of the present invention. As illustrated in FIG. 26, the prediction unit 171e includes a flow classification unit 710, a flow information storage unit 720, a grouping prediction unit 730e, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730e predicts a future traffic amount while suppressing a time required for prediction processing to a calculation amount that falls within an allowable delay by adjusting the number of pieces of prediction processing to be executed in parallel to be within a parallel-processable number. The grouping prediction unit 730e outputs a predicted value of the future traffic amount to the total traffic calculation unit 740.

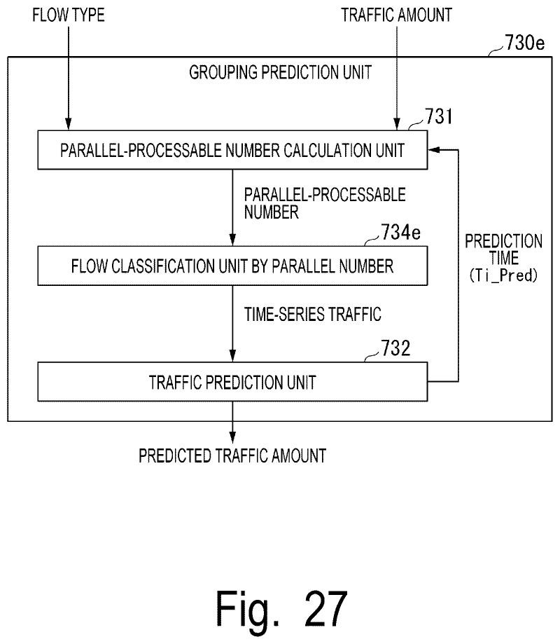

Hereinafter, the configuration of the grouping prediction unit 730e will be described in more detail. FIG. 27 is a block diagram illustrating a functional configuration of the grouping prediction unit 730e of the communication system in the fifth embodiment of the present invention. As illustrated in FIG. 27, the grouping prediction unit 730e includes a parallel-processable number calculation unit 731, a flow classification unit by parallel number 734, and a traffic prediction unit 732.

As illustrated in FIG. 27, the grouping prediction unit 730e in the fifth embodiment has a configuration in which the flow classification unit by parallel number 734 is replaced with the flow classification unit by parallel number 734e with respect to the above-described grouping prediction unit 730c in the third embodiment illustrated in FIG. 20. However, the embodiment is not limited to such a configuration, and for example, the grouping prediction unit 730e in the fifth embodiment may have a configuration in which the flow classification unit by parallel number 734 is replaced with the flow classification unit by parallel number 734e with respect to the above-described grouping prediction unit 730d in the fourth embodiment illustrated in FIG. 23.

The parallel-processable number calculation unit 731 specifies an allowable delay (Delay_a) of each flow on the basis of a flow ID. The parallel-processable number calculation unit 731 specifies the allowable delay (Delay_a) on the basis of, for example, information regarding 5QI or S-NSSAI stored in a storage medium (not illustrated) included in the prediction unit 171e. Note that the information regarding 5QI or S-NSSAI may be stored in the flow information storage unit 720.

For example, as a value of the allowable delay, a value of “PDB” can be used in a case of using the 5QI, and a value of “maximum allowed end-to-end latency” can be used in a case of using the S-NSSAI. Note that, in a case where the flow ID is not related to the allowable delay, for example, use of an arbitrary value of the allowable delay may be determined in advance. Alternatively, in a case of using the S-NSSAI, a specified value set according to a service may be used. Note that, in this case, it is assumed that association between the service and the value of the allowable delay is determined in advance in the flow information table or the like.

The parallel-processable number calculation unit 731 acquires a value of a prediction time (Ti_pred) predicted by the traffic prediction unit 732. The parallel-processable number calculation unit 731 calculates a parallel-processable number (M) on the basis of the allowable delay (Delay_a) and the prediction time (Ti_pred), as given in the following expression (11).

$$M = Delay\_a / Ti\_pred \qquad ( 11 )$$

Note that since the prediction time differs depending on the number of input data (traffic cycle) for each flow, the prediction time (Ti_pred) may be set to a maximum prediction time or an average prediction time. The parallel-processable number calculation unit 731 outputs a calculated value of the parallel-processable number (M) to the flow classification unit by parallel number 734e.

The flow classification unit by parallel number 734e acquires the value of the parallel-processable number (M) output from the parallel-processable number calculation unit 731. The flow classification unit by parallel number 734e compares the acquired parallel-processable number (M) with the actual number of flows.

In a case where the number of flows is equal to or less than the parallel-processable number (M), the prediction processing is completed within an allowable time even if pieces of the prediction processing for the future traffic amount are executed in parallel for all the flows. Therefore, in the case where the number of flows is equal to or less than the parallel-processable number (M), the flow classification unit by parallel number 734e does not need to perform the processing for causing the number of flows to be within the parallel-processable number, and thus does not perform processing of selecting only some flows from all the flows, processing of grouping a plurality of flows into one flow, or the like.

On the other hand, in a case where the number of flows is larger than the parallel-processable number (M), the prediction processing is not completed within the allowable time if pieces of the prediction processing for the future traffic amount are executed in parallel for all the flows. This causes congestion and causes a communication delay. Therefore, in the case where the number of flows is larger than the parallel-processable number (M), the flow classification unit by parallel number 734e groups the flows so that the number of flows becomes the same as the parallel-processable number.

The above-described grouping prediction unit 730 in the first embodiment and the above-described grouping prediction unit 730b in the second embodiment have been configured to select some flows (that is, corresponding to the parallel-processable number (M)) from all the flows classified by the flow classification unit 710 and have performed the prediction processing for the future traffic amount only for the selected flows in the case where the number of flows is larger than the parallel-processable number (M).

Further, the grouping prediction unit 730c in the third embodiment and the grouping prediction unit 730d in the fourth embodiment have been configured to perform grouping for all the flows classified by the flow classification unit 710 so that the number of flows becomes the same as the parallel-processable number, and perform the prediction processing for the future traffic amount in units of groups in the case where the number of flows is larger than the parallel-processable number (M).

In contrast, the grouping prediction unit 730e in the fifth embodiment lists the traffic amounts for each flow for all the flows classified by the flow classification unit 710 in a case where the number of flows is larger than the parallel-processable number (M). Then, the grouping prediction unit 730e is configured to select the same number of flows as the parallel-processable number (M) in descending order of the traffic amount and perform prediction processing for the future traffic amount only for the selected flow.

The flow classification unit by parallel number 734e lists the traffic amounts for each flow for all the flows classified by the flow classification unit 710 in the case where the number of flows is larger than the parallel-processable number (M). Then, the flow classification unit by parallel number 734e selects the same number of flows as the parallel-processable number (M) in descending order of the traffic amount.

The traffic prediction unit 732 performs the prediction processing for the future traffic amount only for the flows selected by the flow classification unit by parallel number 734e. Note that the prediction processing for the future traffic amount is not performed for the flow not selected by the flow classification unit by parallel number 734e, and the current traffic amount is regarded as the future traffic amount (predicted traffic amount). Note that the present embodiment is not limited to such a configuration, and for the flow not selected by the flow classification unit by parallel number 734e (for example, in a case where acquisition of the current traffic amount is not in time), the traffic amount in the period immediately before the present may be regarded as the future traffic amount (predicted traffic amount).

Note that, in the present embodiment, since the flow not selected by the flow classification unit by parallel number 734e is a flow having a relatively small traffic amount, it can be said that the flow has a relatively small influence in the prediction of the entire future traffic amount. That is, the grouping prediction unit 730c in the present embodiment is configured to prioritize a flow having a larger influence in the prediction of the entire future traffic amount and set the flow as a target flow for the prediction processing.

Note that the traffic amount listed for each flow by the flow classification unit by parallel number 734e may be, for example, the current traffic amount, an average traffic amount within a predetermined period, or the maximum traffic amount within a predetermined period.

The flow classification unit by parallel number 734e sums values of traffic amounts of the flows classified into the same group to generate the time-series traffic. The generated time-series traffic is regarded as one flow. The flow classification unit by parallel number 734 outputs the time-series traffic of the grouped one flow and the value of the parallel-processable number (M) acquired from the parallel-processable number calculation unit 731 to the traffic prediction unit 732.

The traffic prediction unit 732 acquires the time-series traffic of the grouped one flow output from the flow classification unit by parallel number 734e and the value of the parallel-processable number (M). The traffic prediction unit 732 predicts the future traffic amount for each flow adjusted to have the same number as the parallel-processable number (M) by the flow classification unit by parallel number 734. The traffic prediction unit 732 outputs a value of the future traffic amount (predicted traffic amount) predicted for each of the M flows to the total traffic calculation unit 740.

As illustrated in FIG. 26, the total traffic calculation unit 740 acquires the value of the predicted traffic amount predicted by the traffic prediction unit 732 of the grouping prediction unit 730e. The total traffic calculation unit 740 adds up the acquired predicted traffic amounts to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171e to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171e is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

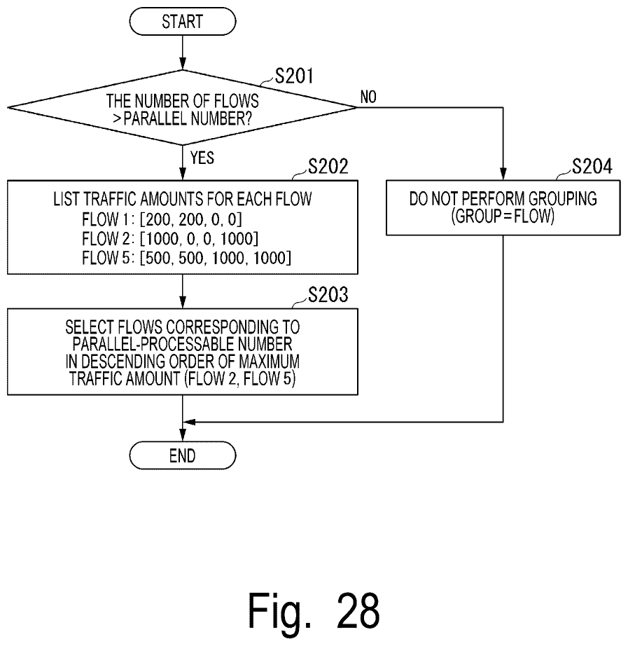

Hereinafter, an example of an operation of the grouping prediction unit 730e will be described. FIG. 28 is a flowchart illustrating an operation of the grouping prediction unit 730e of the communication system in the fifth embodiment of the present invention. The operation of the grouping prediction unit 730e illustrated in the flowchart of FIG. 28 is started when, for example, information used by the parallel-processable number calculation unit 731 (for example, information indicating the flow ID and the traffic amount) is stored in the flow information storage unit 720.

The parallel-processable number calculation unit 731 acquires the information necessary for calculating the future traffic amount (for example, the information indicating the flow ID and the traffic) from the flow information storage unit 720. The parallel-processable number calculation unit 731 specifies an allowable delay (Delay_a) of each flow on the basis of a flow ID. The parallel-processable number calculation unit 731 acquires a value of a prediction time (Ti_pred) predicted by the traffic prediction unit 732. The parallel-processable number calculation unit 731 calculates the parallel-processable number (M) on the basis of the allowable delay (Delay_a) and the prediction time (Ti_pred). The prediction time (Ti_pred) may be a maximum prediction time or an average prediction time. The parallel-processable number calculation unit 731 outputs a calculated value of the parallel-processable number (M) to the flow classification unit by parallel number 734e.

The flow classification unit by parallel number 734e acquires the value of the parallel-processable number (M) output from the parallel-processable number calculation unit 731. The flow classification unit by parallel number 734 compares the acquired parallel-processable number (M) with the actual number of flows (step S201).

In the case where the number of flows is equal to or less than the parallel-processable number (M) (step S201: No), the flow classification unit by parallel number 734e does not need to perform the processing for causing the number of flows to be within the parallel-processable number, and thus does not perform processing of grouping a plurality of flows into one flow, or the like (step S204).

On the other hand, in a case where the number of flows is larger than the parallel-processable number (M) (step S201: Yes), the flow classification unit by parallel number 734e groups the flows so that the number of flows becomes the same as the parallel-processable number. The grouping prediction unit 730e lists the traffic amounts for each flow for all the flows classified by the flow classification unit 710 in the case where the number of flows is larger than the parallel-processable number (M) (step S202).

Here, as an example, it is assumed that the number of flows is three and the parallel-processable number is two (M=2). Further, the traffic amounts of these three flows are as follows as illustrated in FIG. 28.
Flow 1: [200,200,0,0]
Flow 2: [1000,0,0,1000]
Flow 5: [500,500,1000,1000]

The flow classification unit by parallel number 734e selects the same number of flows as the parallel-processable number (M) in descending order of the traffic amount (step S203). Here, the flow classification unit by parallel number 734e is assumed to select the same number of flows as the parallel-processable number (M) in order from the flow having the maximum traffic amount in a predetermined period. As illustrated in FIG. 28, since the maximum traffic amount of Flow 1 is 200 and the maximum traffic amounts of Flow 2 and the flow 5 are 1000, the flow classification unit by parallel number 734e selects the two flows of Flow 2 and the flow 5. The flow classification unit by parallel number 734e outputs information indicating the selected flows and the time-series traffic of each flow to the traffic prediction unit 732.

The traffic prediction unit 732 acquires the information indicating the selected flows and the time-series traffic of each flow output from the flow classification unit by parallel number 734. The traffic prediction unit 732 performs the prediction processing for the future traffic amount only for the flows selected by the flow classification unit by parallel number 734e. Note that the prediction processing for the future traffic amount is not performed for the flow not selected by the flow classification unit by parallel number 734e, and the current traffic amount is regarded as the future traffic amount (predicted traffic amount). The traffic prediction unit 732 outputs a value of the future traffic amount (predicted traffic amount) predicted for each of the M flows to the total traffic calculation unit 740.

Thus, the operation of the grouping prediction unit 730e illustrated in the flowchart of FIG. 28 ends.

As described above, the switching instruction apparatus 17e in the fifth embodiment of the present invention classifies each of the flows input from, for example, a lower apparatus 3 in a predetermined period on the basis of a characteristic of the traffic pattern (for example, QoS) based on information defined in, for example, the 5QI or S-NSSAI. The switching instruction apparatus 17e calculates the parallel-processable number, which is the maximum number of flows that allows the prediction processing to be performed in parallel within the range of the allowable delay, on the basis of the allowable delay and the prediction time.

Then, in a case where the number of classified flows is larger than the parallel-processable number, the switching instruction apparatus 17e in the fifth embodiment selects the same number of flows as the parallel-processable number (M) in descending order of the traffic amount. The switching instruction apparatus 17e performs the prediction processing for the future traffic amount only for the selected flows. Since the flow not selected by the flow classification unit by parallel number 734e is a flow having a relatively small traffic amount, it can be said that the flow has a relatively small influence in the prediction of the entire future traffic amount. That is, the switching instruction apparatus 17e in the fifth embodiment is configured to prioritize a flow having a larger influence in the prediction of the entire future traffic amount and set the flow as a target flow for the prediction processing.

Further, for the unselected flow, the switching instruction apparatus 17e in the fifth embodiment does not perform the prediction processing for the future traffic amount, and regards the current traffic amount as the future traffic amount (predicted traffic amount). Then, the switching instruction apparatus 17e adds up the predicted traffic amounts of the selected flows and the unselected flows, and performs execution determination and execution control of path switching on the basis of the calculated total traffic amount.

As described above, the switching instruction apparatus 17e in the fifth embodiment of the present invention narrows down the number of flows for predicting the predicted traffic amount in parallel so as to fall within the range of the parallel-processable number that enables completion of the prediction processing within the allowable time in the prediction of the path switching. As a result, the switching instruction apparatus 17e can always complete the prediction processing before the timing at which the path switching is required (that is, the timing at which congestion occurs).

Therefore, the switching instruction apparatus 17e can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17e in the fifth embodiment of the present invention can reduce the communication delay while satisfying the communication quality even in a case where a plurality of flows is mixed.

### Sixth Embodiment

Hereinafter, a communication system in a sixth embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the sixth embodiment is similar to the block diagram illustrating the functional configuration of the switching instruction apparatus 17 of the conventional communication system 1 illustrated in FIG. 3. Hereinafter, the switching instruction apparatus in the sixth embodiment will be referred to as a switching instruction apparatus 17f. The switching instruction apparatus 17f is, for example, an information processing apparatus such as a general-purpose computer. The switching instruction apparatus 17f of the present embodiment is different from the above-described conventional switching instruction apparatus 17 in a configuration of a prediction unit. Hereinafter, a configuration of a prediction unit 171f of the communication system in the present embodiment will be described.

### [Functional Configuration of Prediction Unit]

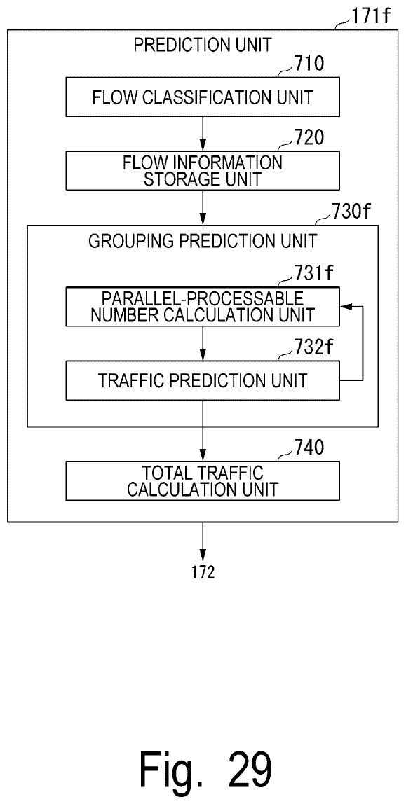

FIG. 29 is a block diagram illustrating a functional configuration of the prediction unit 171f of the communication system in a sixth embodiment of the present invention. As illustrated in FIG. 29, the prediction unit 171f includes a flow classification unit 710, a flow information storage unit 720, a grouping prediction unit 730f, and a total traffic calculation unit 740.

The flow classification unit 710 classifies flows input to a network 5 in a predetermined period on the basis of characteristics of traffic, similarly to the above-described first embodiment. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730f predicts a future traffic amount while suppressing a time required for prediction processing to a calculation amount that falls within an allowable delay by adjusting the number of prediction processing to be executed in parallel to be within a parallel-processable number. The grouping prediction unit 730f outputs a predicted value of the future traffic amount to the total traffic calculation unit 740.

Hereinafter, the configuration of the grouping prediction unit 730f will be described in more detail. The above-described grouping prediction units in the first to fifth embodiments have been configured to calculate the parallel-processable number by which the prediction time falls within the range of the allowable delay on the basis of the allowable delay and the prediction time. In contrast, the grouping prediction unit 730f in the sixth embodiment to be described below is configured to calculate a parallel-processable number to cause a calculation load in prediction processing to fall within a range of a processable resource amount.

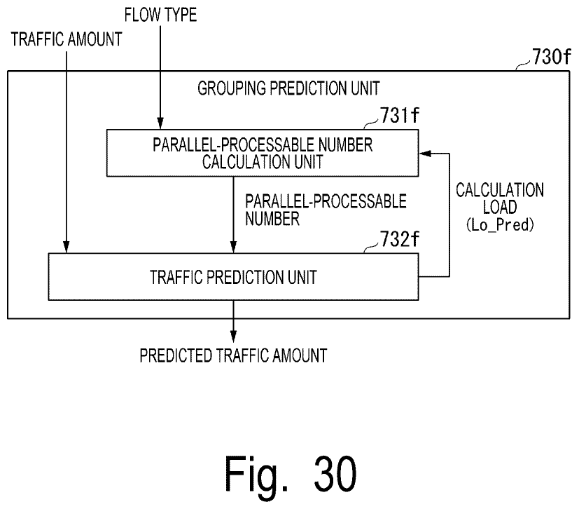

FIG. 30 is a block diagram illustrating a functional configuration of the grouping prediction unit 730f of the communication system in the sixth embodiment of the present invention. As illustrated in FIG. 30, the grouping prediction unit 730f includes a parallel-processable number calculation unit 731f and a traffic prediction unit 732f.

As illustrated in FIG. 30, the grouping prediction unit 730f in the sixth embodiment has a configuration in which the parallel-processable number calculation unit 731 is replaced with the parallel-processable number calculation unit 731f with respect to the above-described grouping prediction unit 730 in the first embodiment illustrated in FIG. 16. Note that the present embodiment is not limited to such a configuration, and it is also possible to replace the parallel-processable number calculation unit in each of the above-described embodiment is replaced with the parallel-processable number calculation unit 731f in the sixth embodiment to be described below. That is, it is also possible to have a configuration to calculate the parallel-processable number to cause the calculation load in the prediction processing to fall within the range of the processable resource amount instead of the configuration to calculate the parallel-processable number to cause the prediction time to fall within the range of the allowable delay even in the above-described first to fifth embodiments.

The parallel-processable number calculation unit 731f acquires a value of a resource amount (Re) from, for example, a controller or the like of an upper apparatus. Alternatively, it is assumed that the value of the resource amount (Re) is known.

The parallel-processable number calculation unit 731f acquires information indicating a calculation load per prediction (Lo_pred) (hereinafter simply referred to as a “calculation load”) measured by the traffic prediction unit 732f. The parallel-processable number calculation unit 731f calculates a parallel-processable number (M) on the basis of the current resource amount (Re_pred) and the past calculation load (Lo_pred) as given in the following expression (12).

$$M = Re\_pred / Lo\_pred \qquad ( 12 )$$

Alternatively, the parallel-processable number calculation unit 731f may calculate the parallel-processable number (M) on the basis of a past entire calculation load (Lo_old) measured by the traffic prediction unit 732f and the past parallel-processable number (M_old) as given in the following expression (13).

$$M = Re\_pred / Lo\_old \times M\_old \qquad ( 13 )$$

The traffic prediction unit 732f acquires the value of the parallel-processable number (M) output from the parallel-processable number calculation unit 731f. The traffic prediction unit 732f narrows down the number of flows to fall within the parallel-processable number (M), and predicts the future traffic amount (predicted traffic amount). The traffic prediction unit 732f in the present embodiment narrows down the number of flows for performing the prediction processing by randomly selecting M flows from all the classified flows, for example.

Note that the number of selected flows may be any number as long as it is M or less. Note that since prediction accuracy of the future traffic amount decreases as the number of selected flows decreases, the number of selected flows is desirably M, which is the maximum number of flows (that is, the parallel-processable number) that can be predicted in parallel within an allowable time.

Note that, in the present embodiment, the traffic prediction unit 732 is configured to randomly select M flows, but the embodiment is not limited to this configuration. The traffic prediction unit 732 may be configured to select the M flows according to an arbitrary rule.

The traffic prediction unit 732f predicts the future traffic amounts for the selected M flows. The traffic prediction unit 732 outputs the value of the future traffic amount (predicted traffic amount) predicted for each of the M flows to the total traffic calculation unit 740.

As illustrated in FIG. 29, the total traffic calculation unit 740 acquires the value of the predicted traffic amount of each of the M flows predicted by the traffic prediction unit 732f of the grouping prediction unit 730f. The total traffic calculation unit 740 adds up the acquired predicted traffic amounts to obtain a value of a total traffic amount. The total traffic calculation unit 740 outputs the calculated value of the total traffic amount to the switching threshold determination unit 172.

Processing after the value of the total traffic amount is output from the total traffic calculation unit 740 of the prediction unit 171f to the switching threshold determination unit 172 (that is, processing related to determination of execution of path switching and processing related to execution control of the path switching) is similar to the processing in the conventional communication system 1, and thus description thereof is omitted. That is, processing in the subsequent stage after the processing by the prediction unit 171f is similar to the processing related to the control of the path switching by the switching threshold determination unit 172 and the switching determination unit 175 and the processing related to the path switching by the transfer apparatus 15 of the conventional communication system 1 described with reference to FIGS. 9 to 12 and the like, and thus description thereof is omitted.

As described above, the switching instruction apparatus 17f in the sixth embodiment of the present invention classifies each of the flows input from, for example, a lower apparatus 3 in a predetermined period on the basis of a characteristic of the traffic pattern (for example, QoS) based on information defined in, for example, the 5QI or S-NSSAI. The switching instruction apparatus 17f calculates the parallel-processable number, which is the maximum number of flows for performing pieces of the prediction processing in parallel with the calculation load within the range of the processable resource amount, on the basis of the processable resource amount and the calculation load in the prediction processing. The switching instruction apparatus 17f randomly selects M flows from all the classified flows input in a predetermined period, and calculates the future traffic amounts (predicted traffic amounts) of the selected M flows. The switching instruction apparatus 17f adds up the predicted traffic amounts calculated for the respective selected flows, and performs execution determination and execution control of the path switching on the basis of the total traffic amount.

As described above, the switching instruction apparatus 17f in the sixth embodiment of the present invention narrows down the number of flows for predicting the predicted traffic amount in parallel so as to cause the calculation load in the prediction processing to fall within the range of the processable resource amount. As a result, the switching instruction apparatus 17f can always complete the prediction processing before the timing at which the path switching is required (that is, the timing at which congestion occurs).

Therefore, the switching instruction apparatus 17f can prevent occurrence of congestion and reduce the communication delay by controlling the calculation load in the prediction processing to fall within the range of the processable resource amount while improving the communication quality by controlling the path switching in advance on the basis of the predicted traffic amount. As described above, the switching instruction apparatus 17f in the sixth embodiment of the present invention can reduce the communication delay while satisfying the communication quality even in a case where a plurality of flows is mixed.

### Seventh Embodiment

Hereinafter, a communication system in a seventh embodiment of the present invention will be described. Note that an overall configuration of the communication system in the present embodiment is similar to the configuration of the conventional communication system 1 illustrated in the overall configuration diagram of FIG. 1 described above, and thus description thereof is omitted. Further, an overall configuration of a mobile communication system in which the communication system in the present embodiment is applied to mobile communication is also similar to the configuration of the conventional mobile communication system 10 illustrated in the overall configuration diagram of FIG. 2 described above, and thus description thereof is omitted.

Further, a block diagram illustrating a functional configuration of a switching instruction apparatus of the communication system in the seventh embodiment is similar to the block diagram illustrating the functional configuration of the switching instruction apparatus 17 of the conventional communication system 1 illustrated in FIG. 3. Hereinafter, the switching instruction apparatus in the seventh embodiment will be referred to as a switching instruction apparatus 17g. The switching instruction apparatus 17g is, for example, an information processing apparatus such as a general-purpose computer. The switching instruction apparatus 17g of the present embodiment is different from the above-described conventional switching instruction apparatus 17 in configurations of a prediction unit, a switching threshold determination unit, and a switching determination unit. Hereinafter, configurations of a prediction unit 171g, a switching threshold determination unit 172g, and a switching determination unit 175g of the communication system in the present embodiment will be described.

### [Functional Configuration of Prediction Unit]

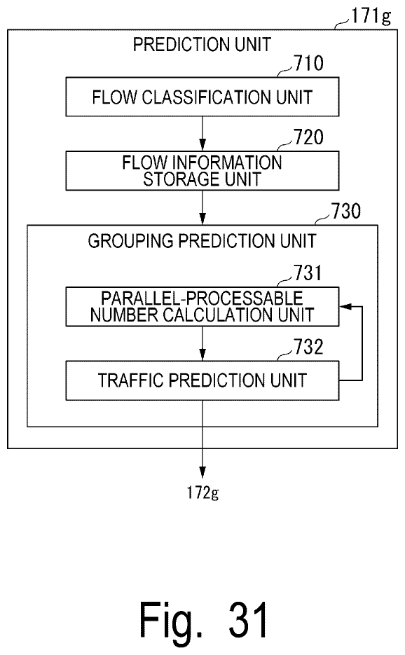

FIG. 31 is a block diagram illustrating a functional configuration of the prediction unit 171g of the communication system in the seventh embodiment of the present invention. As illustrated in FIG. 31, the prediction unit 171g includes a flow classification unit 710, a flow information storage unit 720, and a grouping prediction unit 730.

The flow classification unit 710 classifies flows input to a network 5 in a predetermined period (for example, 1 millisecond, 1 second, or the like) on the basis of characteristics of traffic. The flow classification unit 710 classifies the flows according to a flow type based on information defined in, for example, 5QI, S-NSSAI, or the like. The flow classification unit 710 calculates the number of terminals and a total value of traffic amounts for each classified flow, and stores the calculated data in a flow information table stored in the flow information storage unit 720.

The grouping prediction unit 730 calculates a parallel-processable number on the basis of a predetermined allowable delay and a prediction time. The grouping prediction unit 730 predicts a future traffic amount while suppressing a time required for prediction processing to a calculation amount that falls within the allowable delay by adjusting the number of pieces of prediction processing to be executed in parallel to be within the parallel-processable number. The grouping prediction unit 730 outputs a predicted value of the future traffic amount to the switching threshold determination unit 172g to be described below.

The above-described prediction units of the first to sixth embodiments have included the total traffic calculation unit 740, and the traffic prediction unit has been configured to output the predicted value of the predicted future traffic amount to the total traffic calculation unit 740. Then, the total traffic calculation unit 740 has been configured to acquire and add up the values of the predicted traffic amounts of the respective flows of the parallel-processable number from the traffic prediction unit, and output the value of the total traffic amount to the switching threshold determination unit.

In contrast, in the seventh embodiment, the prediction unit 171f does not include a total traffic calculation unit 740, and instead, the switching threshold determination unit 172g to be described below includes a total traffic calculation unit 740g.

The above-described switching instruction apparatuses of the first to sixth embodiments are different from the switching instruction apparatus of the seventh embodiment in a path switching method. Specifically, the above-described switching instruction apparatuses of the first to sixth embodiments have been configured to perform the path switching in units of the lower apparatuses 3 on the basis of the predicted traffic amount, but the switching instruction apparatus of the seventh embodiment is configured to perform path switching for each flow on the basis of a predicted traffic amount.

As illustrated in FIG. 31, the grouping prediction unit 730 includes a parallel-processable number calculation unit 731 and a traffic prediction unit 732.

The parallel-processable number calculation unit 731 specifies an allowable delay (Delay_a) of each flow on the basis of a flow ID. The parallel-processable number calculation unit 731 specifies the allowable delay (Delay_a) on the basis of, for example, information regarding 5QI or S-NSSAI stored in a storage medium (not illustrated) included in the prediction unit 171g. For example, as a value of the allowable delay, a value of “PDB” can be used in a case of using the 5QI, and a value of “maximum allowed end-to-end latency” can be used in a case of using the S-NSSAI.

Note that, in a case where the flow ID is not related to the allowable delay, for example, use of an arbitrary value of the allowable delay may be determined in advance. Alternatively, in a case of using the S-NSSAI, a specified value set according to a service may be used. Note that, in this case, it is assumed that association between the service and the value of the allowable delay is determined in advance in the flow information table or the like.

The parallel-processable number calculation unit 731 acquires information indicating a value of a prediction time (Ti_pred) predicted by the traffic prediction unit 732. The parallel-processable number calculation unit 731 calculates the parallel-processable number (M) on the basis of the allowable delay (Delay_a) and the prediction time (Ti_pred). The parallel-processable number calculation unit 731 outputs a calculated value of the parallel-processable number (M) to the traffic prediction unit 732.

The traffic prediction unit 732 acquires the value of the parallel-processable number (M) output from the parallel-processable number calculation unit 731. The traffic prediction unit 732 narrows down the number of flows to fall within the parallel-processable number (M), and predicts the future traffic amount (predicted traffic amount). The traffic prediction unit 732 according to the present embodiment narrows down the number of flows for performing the prediction processing by randomly selecting M flows from all the classified flows. Note that, in the present embodiment, the traffic prediction unit 732 is configured to randomly select M flows, but the embodiment is not limited to this configuration. The traffic prediction unit 732 may be configured to select the M flows according to an arbitrary rule.

The traffic prediction unit 732 predicts the future traffic amounts for the selected M flows. The traffic prediction unit 732 outputs a value of the future traffic amount (predicted traffic amount) predicted for each of the M flows to the switching threshold determination unit 172g.

### [Configurations of Switching Threshold Determination Unit and Switching Determination Unit]

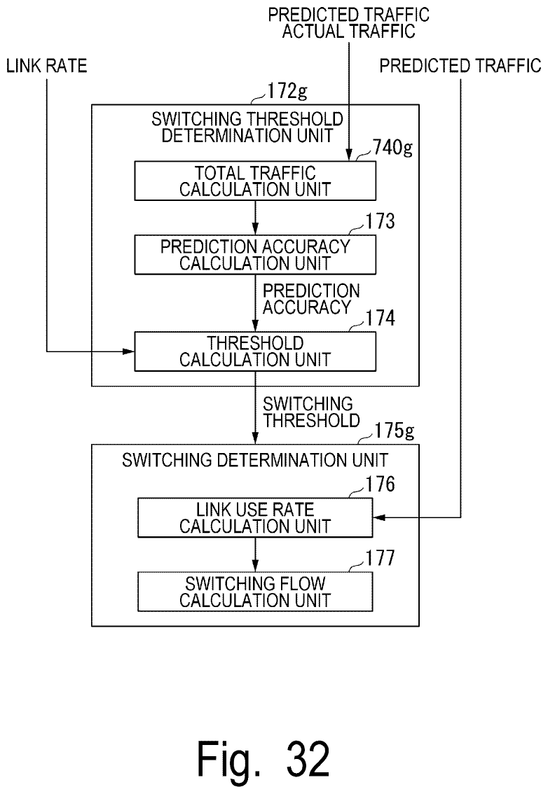

Hereinafter, configurations of the switching threshold determination unit 172g and the switching determination unit 175g of the switching instruction apparatus 17g in the seventh embodiment will be described. FIG. 32 is a block diagram illustrating functional configurations of the switching threshold determination unit 172g and the switching determination unit 175g of the switching instruction apparatus 17g in the seventh embodiment of the present invention.

As illustrated in FIG. 32, the switching threshold determination unit 172g includes the total traffic calculation unit 740g, a prediction accuracy calculation unit 173, and a threshold calculation unit 174.

The total traffic calculation unit 740g acquires the value of the predicted traffic amount predicted by the traffic prediction unit 732 of the grouping prediction unit 730. The total traffic calculation unit 740g calculates a total traffic amount (hereinafter referred to as a “total actual traffic amount”) of the actual traffic in units of lower apparatuses 3 and a total traffic amount (hereinafter also referred to as a “total predicted traffic amount”) in units of the lower apparatuses 3. The total traffic calculation unit 740g outputs a calculated value of the total actual traffic amount and a calculated value of the total predicted traffic amount to the prediction accuracy calculation unit 173.

The prediction accuracy calculation unit 173 acquires the value of the total actual traffic amount and the value of the total predicted traffic amount output from the total traffic calculation unit 740g. The prediction accuracy calculation unit 173 calculates prediction accuracy for each upper link on the basis of the future traffic amount predicted in the past by the prediction unit 171 and the total actual traffic amount. The prediction accuracy calculation unit 173 outputs information indicating the calculated prediction accuracy to the threshold calculation unit 174.

The threshold calculation unit 174 acquires the information indicating the prediction accuracy output from the prediction accuracy calculation unit 173. The threshold calculation unit 174 calculates the switching threshold for each upper link on the basis of the link rate and the prediction accuracy. The threshold calculation unit 174 outputs the switching threshold of each upper link to the switching determination unit 175g.

As illustrated in FIG. 32, the switching determination unit 175g includes a link use rate calculation unit 176 and a switching flow calculation unit 177.

The link use rate calculation unit 176 acquires the switching threshold of each upper link output from the threshold calculation unit 174. Further, the link use rate calculation unit 176 acquires the value of the total predicted traffic amount from the total traffic calculation unit 740g. The link use rate calculation unit 176 calculates a predicted link use rate for each upper link on the basis of the value of the total predicted traffic amount and the switching threshold. The link use rate calculation unit 176 outputs a calculated value of the link use rate to the switching flow calculation unit 177.

The switching flow calculation unit 177 acquires the value of the link use rate output from the link use rate calculation unit 176. The switching flow calculation unit 177 determines to perform the path switching in a case where there is an upper link that has been determined to have congestion due to a high predicted link use rate, and specifies the path switching that will have a traffic amount in which no congestion occurs in order from a flow with low priority. When determining to perform the path switching, the switching flow calculation unit 177 instructs each apparatus (for example, each of the lower apparatus 3, an upper apparatus 4, and a transfer apparatus 15) to perform the specified path switching.

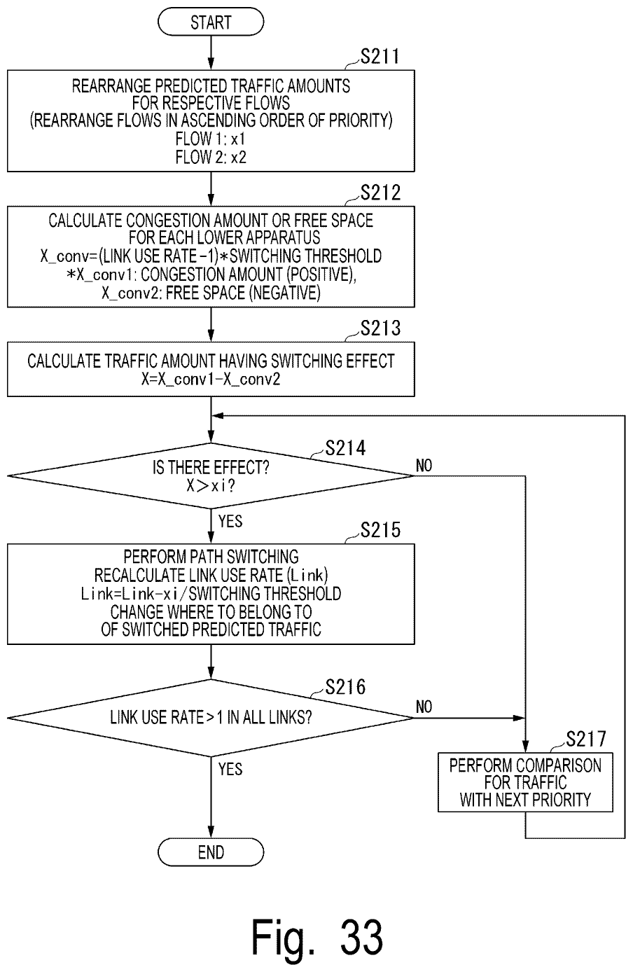

Hereinafter, an example of an operation of the switching flow calculation unit 177 will be described in more detail with a specific example. FIG. 33 is a flowchart illustrating the operation of the switching flow calculation unit 177 of the switching determination unit 175g in the seventh embodiment of the present invention.

The switching flow calculation unit 177 acquires the predicted traffic amounts and rearranges the predicted traffic amounts for the respective flows. The switching flow calculation unit 177 rearranges the flows in ascending order of priority (step S211).

In addition, the switching flow calculation unit 177 calculates a congestion amount (alternatively, a free space in a case of a negative value) for each lower apparatus 3 on the basis of the link use rate of each lower apparatus 3 and the switching threshold as in the following expression (14) (step S212).

X_conv=(link use rate−1)×switching threshold (14)

Hereinafter, X_conv that is a positive value is represented as “X_conv1”, and X_conv that is a negative value is represented as “X_conv2”.

The switching flow calculation unit 177 specifies the lower apparatus 3 having a maximum value of the congestion amount and the lower apparatus 3 having a minimum value of the congestion amount (that is, a maximum value of the free space). The switching flow calculation unit 177 calculates a maximum value of the traffic amount having an effect of the path switching on the basis of the maximum value of the congestion amount and the maximum value of the free space (step S213).

For example, in a case where the congestion amount of the first lower apparatus 3 is the maximum and the congestion amount of the second lower apparatus 3 is the minimum (that is, the free space is maximum), the maximum value of the traffic amount having the effect of the path switching is expressed by the following expression (15).

$$X = X\_conv1 - X\_conv2 \qquad ( 15 )$$

The switching flow calculation unit 177 determines whether or not there is an effect of the path switching by performing the path switching in order from a flow with low priority (step S214).

In a case of determining that there is an effect of the path switching (X>Xi) (step S214: Yes), the switching flow calculation unit 177 issues an instruction to perform the path switching. The switching flow calculation unit 177 causes the link use rate calculation unit 176 to recalculate the link use rate (Link).

$$Link = Link - xi / switching threshold \qquad ( 16 )$$

The switching flow calculation unit 177 changes the lower apparatus 3 to which the switched predicted traffic belongs (step S215).

On the other hand, in a case of determining that there is no effect of the path switching (X≤Xi) (step S214: No), the switching flow calculation unit 177 performs comparison for the flow with the next priority (step S217). Note that, in the present embodiment, the comparison is performed in order from a flow with lower priority, but the present embodiment is not limited to such a configuration. For example, the comparison may be performed in order from a flow with a larger traffic amount.

Note that, in a case of performing the path switching for each flow, the switching flow calculation unit 177 notifies the transfer apparatus 15 (switching apparatus) of a differentiated services code point (DSCP) of a flow for which the path switching is to be performed since there is a correspondence between the DSCP and the 5QI.

When the execution determination of the path switching is completed, the switching flow calculation unit 177 again determines whether or not congestion has occurred on the basis of a new link use rate. In a case where the values of all the link use rates are not 1 (that is, the link use rates >1), the switching flow calculation unit 177 terminates the processing.

Thus, the operation of the switching flow calculation unit 177 illustrated in the flowchart of FIG. 33 ends.

As described above, the switching instruction apparatus 17g in the seventh embodiment of the present invention classifies each of the flows input from, for example, the lower apparatus 3 in a predetermined period on the basis of a characteristic of a traffic pattern (for example, QoS) based on information defined in, for example, the 5QI or S-NSSAI. The switching instruction apparatus 17g calculates the parallel-processable number, which is the maximum number of flows for performing pieces of the prediction processing to be performed in parallel within the range of the allowable delay, on the basis of the allowable delay and the prediction time. The switching instruction apparatus 17g randomly selects M flows from all the classified flows input in a predetermined period, and calculates the future traffic amounts (predicted traffic amounts) of the selected M flows. Further, the above-described switching instruction apparatuses of the first to sixth embodiments have been configured to perform the path switching in units of the lower apparatuses 3 on the basis of the predicted traffic amount, but the switching instruction apparatus of the seventh embodiment is configured to perform the path switching for each flow on the basis of the predicted traffic amount.

As described above, the switching instruction apparatus 17g in the seventh embodiment of the present invention narrows down the number of flows for predicting the predicted traffic amount in parallel so as to fall within the range of the parallel-processable number that enables completion of the prediction processing within an allowable time in the prediction of the path switching. As a result, the switching instruction apparatus 17g can always complete the prediction processing before the timing at which the path switching is required (that is, the timing at which congestion occurs).

Therefore, the switching instruction apparatus 17g can prevent occurrence of congestion and reduce the communication delay by controlling the prediction processing to be completed within the allowable time while improving the communication quality by controlling the path switching in advance on the basis of the predicted traffic amount. As described above, the switching instruction apparatus 17g in the seventh embodiment of the present invention can reduce the communication delay while satisfying the communication quality even in a case where a plurality of flows is mixed.

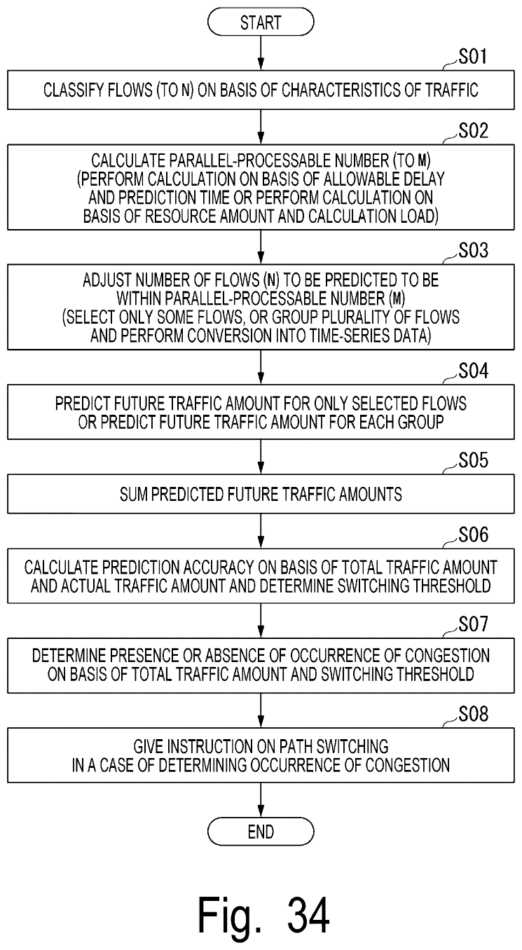

Hereinafter, basic configurations common to the switching instruction apparatuses in the above-described embodiments will be rearranged and described. FIG. 34 is a diagram illustrating a basic processing flow by the switching instruction apparatus in each embodiment of the present invention.

First, the flow classification unit classifies the flows input to the network 5 in a predetermined period (for example, 1 millisecond, 1 second, or the like) on the basis of characteristics of traffic (step S01). The characteristics of traffic are, for example, the QoS, the traffic pattern, the traffic cycle, and the like. Here, the number of flows collected by classification by the flow classification unit is assumed to be N. In addition, in the following description, a flow is a flow collected by classification by the flow classification unit, that is, a flow obtained by collecting flows having the same characteristics of traffic into one flow.

Next, the parallel-processable number calculation unit calculates the parallel-processable number (step S02). Here, the parallel-processable number calculated by the parallel-processable number calculation unit is assumed to be M. The parallel-processable number is the maximum number of the prediction processing that can be completed within the range of the allowable delay in a case where pieces of the prediction processing for the future traffic amount are executed in parallel for a plurality of flows. The parallel-processable number calculation unit calculates the parallel-processable number on the basis of the allowable delay and the prediction time. Alternatively, the parallel-processable number calculation unit calculates the parallel-processable number on the basis of the resource amount and the calculation load. For example, in the first embodiment, the parallel-processable number calculation unit calculates the parallel-processable number by the former method, and in the sixth embodiment, the parallel-processable number calculation unit calculates the parallel-processable number by the latter method.

Next, in a case where the number of flows (N) is larger than the parallel-processable number (M), the traffic prediction unit 732 adjusts the number of flows targeted for performing the prediction processing for the future traffic amount to be at most the parallel-processable number (M) (step S03). This is because, in a case where the prediction processing is performed in parallel for the number of flows exceeding the parallel-processable number, the prediction processing cannot be completed before the prediction target period, congestion may occur, and a communication delay may occur.

Note that, in a case where the number of flows (N) is already within the parallel-processable number (M), it is not necessary to perform adjustment to reduce the number of flows targeted for performing the prediction processing. This is because even if the prediction processing is performed in parallel for all the (that is, N) flows classified by the flow classification unit, all pieces of the prediction processing can be completed before the prediction target period.

As a method by which the traffic prediction unit 732 adjusts the number of flows targeted for performing the prediction processing for the future traffic amount to be at most the parallel-processable number (M), there is a method of selecting only the parallel-processable number (M) of flows at most from all the (that is, N) flows classified by the flow classification unit and performing the prediction processing only for the selected flows. For example, in the above-described first and second embodiments, the traffic prediction unit 732 adjusts the number of flows targeted for the prediction processing. In this case, since the prediction process is not performed for the unselected flow, for example, the past traffic amount is regarded as the future traffic amount as it is.

As a method by which the traffic prediction unit 732 adjusts the number of flows targeted for performing the prediction processing for the future traffic amount to be at most the parallel-processable number (M), there is a method of grouping all the (that is, N) flows classified by the flow classification unit into a necessary number of groups and adjusting the number of groups to be at most the parallel-processable number (M), and performing the prediction processing in units of groups. For example, in the above-described third and fourth embodiments, the traffic prediction unit 732 adjusts the number of flows targeted for the prediction processing.

Next, in a case of adjusting the number of flows by selecting only at most the parallel-processable number (M) of flows from all the (that is, N) flows, the traffic prediction unit 732 performs the prediction processing for the future traffic amount only for the selected flows. On the other hand, in a case of adjusting the number of groups to be predicted by grouping all the (that is, N) flows into the necessary number of groups, the traffic prediction unit 732 performs the prediction processing for the future traffic amount for each group (step S04).

Next, the total traffic calculation unit adds up the future traffic amounts obtained by the prediction processing by the traffic prediction unit to calculate the total traffic amount (step 05). At this time, in the case where the number of flows is adjusted by selecting only at most the parallel-processable number (M) of flows from all the (that is, N) flows, the total traffic calculation unit regards, for example, the past traffic amount as the future traffic amount as it is and performs the above-described adding processing for the unselected flows.

Next, the prediction accuracy calculation unit of the switching threshold determination unit acquires the value of the total traffic amount calculated by the total traffic calculation unit. The prediction accuracy calculation unit calculates the prediction accuracy for each link on the basis of the total traffic amount calculated in the past (for example, a time period (t−1)) and the actual traffic amount at present (for example, a time period (t)). The threshold calculation unit of the switching threshold determination unit determines the switching threshold for each link so that the lower the prediction accuracy, the lower the ratio to the transmission capability of the link (for example, the link rate) (step S06).

Next, the switching determination unit determines in advance the presence or absence of occurrence of congestion on the basis of the value of the total traffic amount and the switching threshold for each link (step S07).

Next, in a case where occurrence of congestion is predicted, the switching determination unit determines to perform the path switching for load distribution. For example, the switching determination unit determines to execute the path switching from a link in which occurrence of congestion is predicted to a link with a low link use rate. The switching determination unit instructs the transfer apparatus and the like, which perform the path switching, to perform processing for the path switching (step S08).

The above is the basic processing flow common to the switching instruction apparatus in each of the above-described embodiments.

Hereinafter, an example of execution timing of the flow grouping processing (classification processing) by the flow classification unit by parallel number 734 in the third embodiment and the flow classification unit by parallel number 734 in the fourth embodiment will be described.

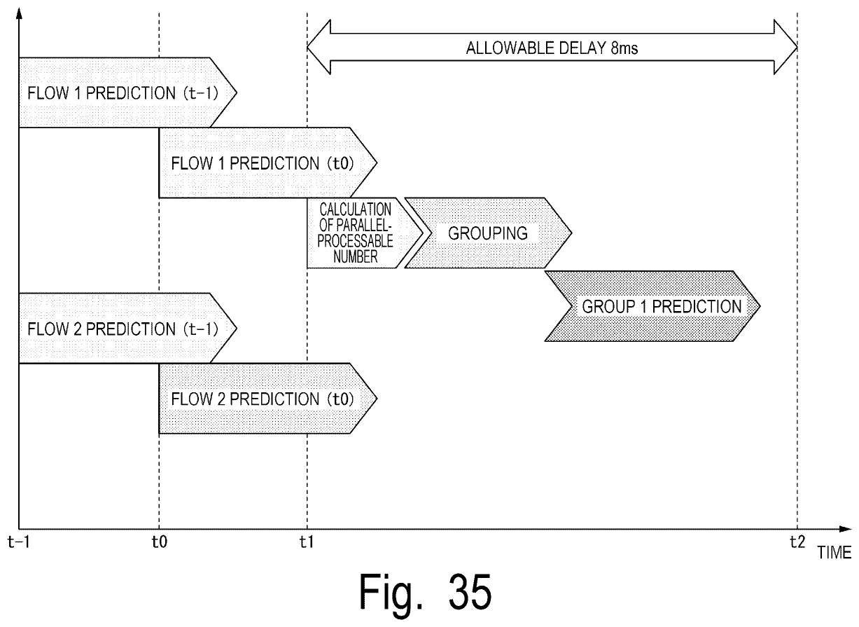

FIG. 35 is a diagram for describing the execution timing of the grouping processing by the flow classification unit by parallel number in each embodiment of the present invention. In the example illustrated in FIG. 35, the number of flows before grouping is two, and there are Flow 1 in which the time required for prediction (prediction time) is 5 milliseconds and Flow 2 in which the prediction time is also 5 milliseconds. Note that the number of flows changes as needed in time series.

Further, the delay time (allowable delay) allowed for the prediction processing for the future traffic amount (predicted traffic amount) in each period is assumed to be within 8 milliseconds for each flow.

In the example illustrated in FIG. 35, a state in which the prediction processing for each flow is repeated at an interval of time (t0)-time (t−1) is illustrated. For example, as illustrated in FIG. 35, the prediction processing for the future traffic amount for Flow 1 and the prediction processing for the future traffic amount for Flow 2 are simultaneously started at the timing of time (t−1). Next, similarly, the prediction processing for the future traffic amount for Flow 1 and the prediction processing for the future traffic amount for Flow 2 are simultaneously started again at the timing of time (t).

As described above, in both of Flow 1 and Flow 2, the time required for prediction (prediction time) is 5 milliseconds. However, as illustrated in FIG. 35, the prediction processing started at the timing of time (t−1) has not been completed by time (t0). Therefore, the interval between time (t0) and time (t−1) is less than 5 milliseconds. Therefore, in this case, the result of the prediction processing started at the timing of time (t−1) is used for the processing of grouping the flows started from the time (t1), which is the start timing of the period two periods ahead.

In the processing of grouping the flows starting from the time (t1), first, the parallel-processable number is calculated. Here, in a case where pieces of the prediction processing are performed in parallel for Flow 1 in which the prediction time is 5 milliseconds and for Flow 2 in which the prediction time is also 5 milliseconds, a total of 10 (=5+5) milliseconds is required. In this case, the parallel-processable number can be obtained by dividing the total prediction time by the allowable time, and the allowable time is 8 milliseconds as described above, and thus the parallel-processable number can be obtained as within 1.6 (=10/8) (that is, one).

Next, necessity of performing the grouping is determined on the basis of the calculated parallel-processable number. In the example illustrated in FIG. 35, since the number of flows is two while the parallel-processable number is one, it is determined that grouping is necessary. Then, Flow 1 and Flow 2 are grouped into one group (Group 1).

Thereafter, the prediction processing is performed on the basis of the time-series traffic obtained by adding the traffic of Flow 1 and the traffic of Flow 2 belonging to Group 1. Since the traffic is summed, the prediction time of the future traffic amount for Group 1 is 5 milliseconds. Therefore, the prediction time is within 8 milliseconds of the allowable delay, and thus the prediction processing can be completed within the range of the allowable delay.

Thereafter, the presence or absence of congestion is determined on the basis of the future traffic amount predicted for the time-series traffic in units of groups, and the path switching is performed as necessary.

Hereinafter, another example of the execution timing of the flow grouping processing (classification processing) by the flow classification unit by parallel number 734 in the third embodiment and the flow classification unit by parallel number 734 in the fourth embodiment will be described.

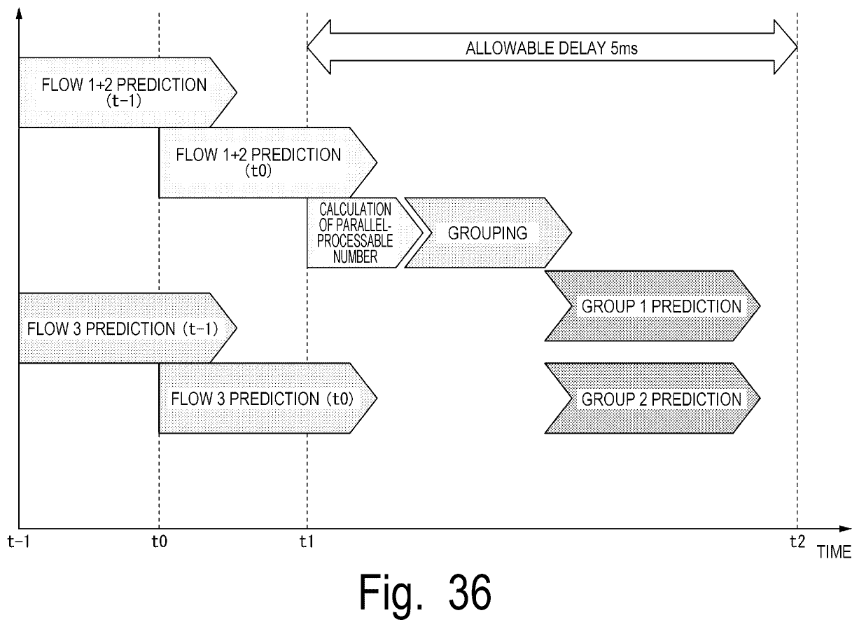

FIG. 36 is a diagram for describing the execution timing of the grouping processing by the flow classification unit by parallel number in each embodiment of the present invention. In the example illustrated in FIG. 36, the number of flows before grouping is three. However, unlike the above-described example illustrated in FIG. 35, Flow 1 and Flow 2 have already been grouped, and it is assumed that there are grouped Flow 1+Flow 2 in which the time required for prediction (prediction time) is 4 milliseconds and Flow 3 in which the prediction time is 45 milliseconds. Note that the number of flows changes as needed in time series.

Further, the delay time (allowable delay) allowed for the prediction processing for the future traffic amount (predicted traffic amount) in each period is assumed to be within 5 milliseconds for each flow.

The example illustrated in FIG. 36 illustrates a state in which the prediction processing for each flow is repeated at an interval of time (t0)-time (t−1). For example, as illustrated in FIG. 36, the prediction processing for the future traffic amount for Flow 1+2 and the prediction processing for the future traffic amount for Flow 3 are simultaneously started at the timing of time (t−1). Next, similarly, the prediction processing for the future traffic amount for Flow 1+2 and the prediction processing for the future traffic amount for Flow 3 are simultaneously started again at the timing of time (t).

As described above, in both of Flow 1+2 and Flow 3, the time required for prediction (prediction time) is 4 milliseconds. However, as illustrated in FIG. 36, the prediction processing started at the timing of time (t−1) has not been completed by time (t0). Therefore, the interval between time (t0) and time (t−1) is less than 4 milliseconds. Therefore, in this case, the result of the prediction processing started at the timing of time (t−1) is used for the processing of grouping the flows started from the time (t1), which is the start timing of the period two periods ahead.

In the processing of grouping the flows starting from the time (t1), first, the parallel-processable number is calculated. Here, in a case where pieces of the prediction processing are performed in parallel for Flow 1+2 in which the prediction time is 4 milliseconds and for Flow 3 in which the prediction time is also 4 milliseconds, a total of 8 (=4+4) milliseconds is required. In this case, the parallel-processable number can be obtained by dividing the total prediction time by the allowable time, and the allowable time is 5 milliseconds as described above, and thus the parallel-processable number can be obtained as within 1.25 (=5/4) (that is, one).

Next, necessity of performing the grouping is determined on the basis of the calculated parallel-processable number. In the example illustrated in FIG. 36, in a case where the already grouped flows are regarded as one flow, the number of flows is two whereas the parallel-processable number is one, and thus it is determined that grouping is necessary. Then, Flow 1+2 and Flow 3 are grouped into one group (Group 1).

Thereafter, the prediction processing is performed on the basis of the time-series traffic obtained by adding the traffic of Flow 1+2 and the traffic of Flow 3 belonging to Group 1. Since the traffic is summed, the prediction time of the future traffic amount for Group 1 is 4 milliseconds. Therefore, the prediction time is within 5 milliseconds of the allowable delay, and thus the prediction processing can be completed within the range of the allowable delay.

Thereafter, the presence or absence of congestion is determined on the basis of the future traffic amount predicted for the time-series traffic in units of groups, and the path switching is performed as necessary.

Note that the above-described first to third embodiments are described assuming a case of using traffic captured from the lower apparatus 3. Note that, in each of the above-described embodiments, the network 5 may be any network such as mobile fronthaul (MFH), mobile midhaul (MMH), or mobile backhaul (MBH).

Note that, in each of the above-described embodiments, the switching instruction apparatus may be configured to acquire traffic information from a controller (not illustrated) of the lower apparatus 3 instead of acquiring the traffic information from the lower apparatus 3.

Note that, in each of the above-described embodiments, the switching instruction apparatus may be configured to use the scheduling information (for example, a buffer status report (BSR), a transport block size (TBS), or the like) in a wireless section instead of using the value of the traffic amount when performing the execution determination of the path switching. In this case, the network 5 is, for example, an MMH or an MBH. In addition, a place from which the scheduling information is acquired is, for example, a DU, a DU controller, a CU, or a CU controller.

Note that, in each of the above-described embodiments, the case of upstream communication has been described as an example, but the present invention is not limited thereto, and a similar configuration can be applied to a case of downstream communication.

Note that, in each of the above-described embodiments, the configuration assuming a 5G mobile network has been described, but the present invention is not limited thereto, and for example, a similar configuration can be applied even in a case of another wireless network such as Wi-Fi (registered trademark). In this case, a place from which the traffic information is acquired is, for example, an access point of Wi-Fi (registered trademark). Furthermore, the network 5 is, for example, a network between a Wi-Fi (registered trademark) controller and an access point of Wi-Fi (registered trademark).

As described above, the above-described switching instruction apparatus in each embodiment of the present invention narrows down the number of flows for predicting the predicted traffic amount in parallel. As a result, the switching instruction apparatus can always complete the prediction processing before the timing at which the path switching is required (that is, the timing at which congestion occurs). Therefore, the switching instruction apparatus can prevent occurrence of congestion and reduce the communication delay by controlling the prediction processing to be completed within the allowable time while improving the communication quality by controlling the path switching in advance on the basis of the predicted traffic amount. As described above, the above-described switching instruction apparatus in each embodiment of the present invention can reduce the communication delay while satisfying the communication quality even in a case where a plurality of flows is mixed.

According to the above-described embodiments, the prediction apparatus includes the flow classification unit, the parallel-processable number calculation unit, the traffic prediction unit, and the total traffic calculation unit. For example, the prediction apparatus is the prediction units 71a to 71g in the embodiments, the flow classification unit is the flow classification unit 710 in the embodiments, the parallel-processable number calculation unit is the parallel-processable number calculation units 731, 731b, 731d, and 731f in the embodiments, the traffic prediction unit is the traffic prediction units 732 and 732f in the embodiments, and the total traffic calculation unit is the total traffic calculation units 740 and 740g in the embodiments.

The above-described flow classification unit classifies communication traffic input during a predetermined period into a plurality of flows on the basis of characteristics of the communication traffic. For example, a characteristic of the communication traffic is the flow type based on the information defined in the 5QI, S-NSSAI, or the like in the embodiments. The above-described parallel-processable number calculation unit calculates, on the basis of the traffic amount for each flow in a first period and a predetermined condition, the parallel-processable number that is the maximum number of pieces of the prediction processing completable before a second period that is later than the first period in a case of performing pieces of the prediction processing of predicting the traffic amount in the second period in parallel for respective flows. For example, the traffic amount in the second period is the predicted traffic amount in the embodiment. In a case where the number of flows classified by the flow classification unit is larger than the parallel-processable number, the traffic prediction unit performs the prediction processing for the number of flows within the parallel-processable number. The above-described total traffic calculation unit calculates the total traffic amount in the second period on the basis of the result of the prediction processing by the traffic prediction unit. For example, the total value of the traffic amount in the second period is the total traffic amount in the embodiment.

Note that, in the above-described prediction apparatus, the predetermined condition may be a condition based on the allowable time that is the processing time allowed in the prediction processing and the prediction time that is the time required for the prediction processing. In this case, the parallel-processable number calculation unit calculates the parallel-processable number by determining whether or not the prediction time falls within the allowable time.

Note that, in the above-described prediction apparatus, in a case where the number of flows classified by the flow classification unit is larger than the parallel-processable number, the above-described traffic prediction unit may make the number of performing the prediction processing be within the parallel-processable number by adding up the traffic amounts of the plurality of flows and regarding the plurality of flows as one flow.

Note that, in the above-described prediction apparatus, in a case where a plurality of flows is regarded as one flow, the traffic prediction unit may select a plurality of flows for which the traffic amounts are added up so that the maximum value of the traffic cycle of each of the flows for which the prediction processing is performed becomes small.

Note that, in the above-described prediction apparatus, in a case where the number of flows classified by the flow classification unit is larger than the parallel-processable number, the above-described traffic prediction unit may make the number of performing the prediction processing be within the parallel-processable number by sequentially selecting the flows having a larger maximum value of the past traffic amount among the plurality of flows.

Note that, in the above-described prediction apparatus, the predetermined condition may be a condition based on the processable resource amount in the prediction processing and the calculation load generated in the prediction processing. In this case, the parallel-processable number calculation unit calculates the parallel-processable number by determining whether or not the calculation load falls within the resource amount.

Further, according to the above-described embodiments, the communication control apparatus includes the flow classification unit, the parallel-processable number calculation unit, the traffic prediction unit, the total traffic calculation unit, the switching determination unit, and a switching instruction unit. For example, the prediction apparatus is the prediction units 71a to 71g in the embodiments, the flow classification unit is the flow classification unit 710 in the embodiments, the parallel-processable number calculation unit is the parallel-processable number calculation units 731, 731b, 731d, and 731f in the embodiments, the traffic prediction unit is the traffic prediction units 732 and 732f in the embodiments, and the total traffic calculation unit is the total traffic calculation units 740 and 740g, the switching determination unit is the switching determination units 175 and 175g in the embodiment, and the switching instruction unit is the switching instruction apparatuses 17a to 17g in the embodiments.

The above-described flow classification unit classifies communication traffic input during a predetermined period into a plurality of flows on the basis of characteristics of the communication traffic. For example, a characteristic of the communication traffic is the flow type based on the information defined in the 5QI, S-NSSAI, or the like in the embodiments. The above-described parallel-processable number calculation unit calculates, on the basis of the traffic amount for each flow in a first period and a predetermined condition, the parallel-processable number that is the maximum number of pieces of the prediction processing completable before a second period that is later than the first period in a case of performing pieces of the prediction processing of predicting the traffic amount in the second period in parallel for respective flows. For example, the traffic amount in the second period is the predicted traffic amount in the embodiment. In a case where the number of flows classified by the flow classification unit is larger than the parallel-processable number, the traffic prediction unit performs the prediction processing for the number of flows within the parallel-processable number. The above-described total traffic calculation unit calculates the total traffic amount in the second period on the basis of the result of the prediction processing by the traffic prediction unit. For example, the total value of the traffic amount in the second period is the total traffic amount in the embodiment. The above-described switching determination unit predicts the presence or absence of occurrence of congestion in the second period on the basis of the total value of the traffic amounts, and determines the necessity of switching the communication path on the basis of the prediction result. In a case where the switching determination unit determines that switching of the communication path is necessary, the switching instruction unit gives a switching instruction to the switching apparatus that executes the switching of the communication path. For example, the switching apparatus is the transfer apparatus 15 in the embodiment.

A part or all of the configurations of the switching instruction apparatus in the above-described embodiment may be implemented by a computer. In that case, a program for implementing this function may be recorded in a computer-readable recording medium, and the program recorded in the recording medium may be read and executed by a computer system to implement this function. Note that the “computer system” referred to herein includes an OS and hardware such as peripheral equipment. In addition, the “computer-readable recording medium” refers to a portable medium such as a flexible disk, a magneto-optical disk, a ROM, or a CD-ROM, or a storage apparatus such as a hard disk built in a computer system. Moreover, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside the computer system serving as a server or a client in that case. Furthermore, the program described above may be for implementing some of the functions described above, may be implemented in a combination of the functions described above and a program already recorded in the computer system, or may be implemented using a programmable logic apparatus such as a field programmable gate array (FPGA).

Although the embodiments of the present invention have been described in detail with reference to the drawings, specific configurations are not limited to the embodiments, and include design and the like within the scope of the present invention without departing from the concept of the present invention.

### REFERENCE SIGNS LIST

1 Communication system
3 Lower apparatus
4 Upper apparatus
5 Network
7 Switching instruction apparatus
10 Mobile communication system
11 Terminal station
12 Antenna station
13 Distributed station
14 Aggregation station
15 Transfer apparatus
16 Resource allocation apparatus
17, 17a to 17g Switching instruction apparatus
20 Upper network
71 Prediction unit
72 Switching threshold determination unit
73 Prediction accuracy calculation unit
74 Threshold calculation unit
75 Switching determination unit
171, 171a to 171g Prediction unit
172, 172g Switching threshold determination unit
173 Prediction accuracy calculation unit
174 Threshold calculation unit
175, 175g Switching determination unit
176 Link use rate calculation unit
177 Switching flow calculation unit
710 Flow classification unit
720 Flow information storage unit
730, 730b to 730f Grouping prediction unit
731, 731b, 731d, 731f Parallel-processable number calculation unit
732, 732f Traffic prediction unit
733 Traffic cycle calculation unit
734, 734e Flow classification unit
740, 740g Total traffic calculation unit

1. A prediction apparatus comprising:
a memory; and
a processor connected to the memory, the processor being configured to perform:
classify communication traffic input during a predetermined period into a plurality of flows on a basis of a characteristic of the communication traffic;
calculate a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition;
perform the prediction processing for a number of the flows within the parallel-processable number in a case where the number of flows classified is larger than the parallel-processable number; and
calculate a total of the traffic amounts in the second period on a basis of a result of the prediction processing.

2. The prediction apparatus according to claim 1, wherein
the predetermined condition is a condition based on an allowable time that is a processing time allowed in the prediction processing and a prediction time that is a time required for the prediction processing, and
the processor is configured to calculate the parallel-processable number by determining whether or not the prediction time falls within the allowable time.

3. The prediction apparatus according to claim 2, wherein, in a case where the number of flows is larger than the parallel-processable number, the processor is configured to make a number of performing the prediction processing be within the parallel-processable number by adding up the traffic amounts of a plurality of the flows and regarding the plurality of the flows as one flow.

4. The prediction apparatus according to claim 3, wherein, in a case of regarding a plurality of the flows as one flow, the processor is configured to select a plurality of the flows for adding the traffic amounts such that a maximum value of a traffic cycle of each of the flows for which the prediction processing is performed becomes small.

5. The prediction apparatus according to claim 2, wherein, in a case where the number of flows classified is larger than the parallel-processable number, the processor is configured to make the number of performing the prediction processing be within the parallel-processable number by sequentially selecting the flows having a larger maximum value of the past traffic amount among a plurality of the flows.

6. The prediction apparatus according to claim 1, wherein
the predetermined condition is a condition based on a resource amount processable in the prediction processing and a calculation load generated in the prediction processing, and
the processor is configured to calculate the parallel-processable number by determining whether or not the calculation load falls within the resource amount.

7. A communication control apparatus comprising:
a memory; and
a processor connected to the memory, the processor being configured to perform:
classify communication traffic input during a predetermined period into a plurality of flows on a basis of a characteristic of the communication traffic;
calculate a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition;
perform the prediction processing for a number of the flows within the parallel-processable number in a case where the number of flows classified is larger than the parallel-processable number;
calculate a total of the traffic amounts in the second period on the basis of a result of the prediction processing;
predict presence or absence of occurrence of congestion in the second period on a basis of a total value of the traffic amounts, and determine necessity of switching of a communication path on a basis of a prediction result; and
issue a switching instruction to a switching apparatus that executes the switching of a communication path in a case where it is determined that the switching of a communication path is necessary.

8. A prediction method executed by a computer, the prediction method comprising:
classifying communication traffic input during a predetermined period into a plurality of flows on a basis of a characteristic of the communication traffic;
calculating a parallel-processable number that is a maximum number of pieces of prediction processing completable before a second period is reached in a case where the pieces of prediction processing of predicting a traffic amount in the second period after a first period are performed in parallel for the respective flows on a basis of the traffic amount for each of the flows in the first period and a predetermined condition;
performing the prediction processing for a number of the flows within the parallel-processable number in a case where the number of flows classified is larger than the parallel-processable number; and
calculating a total of the traffic amounts in the second period on the basis of a result of the prediction processing.
